(19) United States
(12) Patent Application Publication
(10) Pub. No.: US 2012/0230423 A1
(43) Pub. Date: Sep. 13, 2012

(54) LINE MEMORY REDUCTION FOR VIDEO CODING AND DECODING

(76) Inventors: Semih ESENLIK, Langen (DE); Matthias Narroschke, Langen (DE); Thomas Wedi, Langen (DE)

(21) Appl. No.: 13/045,067

(22) Filed: Mar. 10, 2011

(51) Int. Cl. H04N 7/68; H04N 7/26; G06K 9/40

(52) U.S. Cl. 375/240.24; 382/260; 375/E07.2; 375/E07.281

(57) ABSTRACT

The present invention relates to filtering of image data at first with a deblocking and then with an adaptive loop filter, suitable for the purpose of video coding and decoding. In order to reduce requirements to a memory on chip, used to buffer image lines necessary for filtering, the input signal for the adaptive loop filter is determined from among deblocked pixels, non-deblocked pixels and partially (horizontally only or vertically only) deblocked pixels. The adaptive loop filtering of a deblocked pixel may then apply the filter taps to already deblocked pixels and/or undeblocked pixels and/or partially deblocked pixels in accordance with the determination of the input signal. An advantage of the invention is reduction of the line memory necessary especially at the decoder for processing with both filters.

### FIELD OF THE INVENTION

The present invention relates to the filtering of images. In particular, the present invention relates to reduction of line memory size necessary for filtering during image coding and/or decoding.

### DESCRIPTION OF THE RELATED ART

At present, the majority of standardized video coding algorithms are based on hybrid video coding. Hybrid video coding methods typically combine several different lossless and lossy compression schemes in order to achieve the desired compression gain. Hybrid video coding is also the basis for ITU-T standards (H.26x standards such as H.261, H.263) as well as ISO/IEC standards (MPEG-X standards such as MPEG-1, MPEG-2, and MPEG-4). The most recent and advanced video coding standard is currently the standard denoted as H.264/MPEG-4 advanced video coding (AVC) which is a result of standardization efforts by joint video team (JVT), a joint team of ITU-T and ISO/IEC MPEG groups. This codec is being further developed by Joint Collaborative Team on Video Coding (JCT-VC) under a name High-Efficiency Video Coding (HEVC), aiming, in particular at improvements of efficiency regarding the high-resolution video coding.

A video signal input to an encoder is a sequence of images called frames, each frame being a two-dimensional matrix of pixels. All the above-mentioned standards based on hybrid video coding include subdividing each individual video frame into smaller blocks consisting of a plurality of pixels. The size of the blocks may vary, for instance, in accordance with the content of the image. The way of coding may be typically varied on a per block basis. The largest possible size for such a block, for instance in HEVC, is 64×64 pixels. It is then called the largest coding unit (LCU). In H.264/MPEG-4 AVC, a macroblock (usually denoting a block of 16×16 pixels) was the basic image element, for which the encoding is performed, with a possibility to further divide it in smaller subblocks to which some of the coding/decoding steps were applied.

Typically, the encoding steps of a hybrid video coding include a spatial and/or a temporal prediction. Accordingly, each block to be encoded is first predicted using either the blocks in its spatial neighborhood or blocks from its temporal neighborhood, i.e. from previously encoded video frames. A block of differences between the block to be encoded and its prediction, also called block of prediction residuals, is then calculated. Another encoding step is a transformation of a block of residuals from the spatial (pixel) domain into a frequency domain. The transformation aims at reducing the correlation of the input block. Further encoding step is quantization of the transform coefficients. In this step the actual lossy (irreversible) compression takes place. Usually, the compressed transform coefficient values are further compacted (losslessly compressed) by means of an entropy coding. In addition, side information necessary for reconstruction of the encoded video signal is encoded and provided together with the encoded video signal. This is for example information about the spatial and/or temporal prediction, amount of quantization, etc.

FIG. 1 is an example of a typical H.264/MPEG-4 AVC and/or HEVC video encoder 100. A subtractor 105 first determines differences e between a current block to be encoded of an input video image (input signal s) and a corresponding prediction block ŝ, which is used as a prediction of the current block to be encoded. The prediction signal may be obtained by a temporal or by a spatial prediction 180. The type of prediction can be varied on a per frame basis or on a per block basis. Blocks and/or frames predicted using temporal prediction are called “inter”-encoded and blocks and/or frames predicted using spatial prediction are called “intra”-encoded. Prediction signal using temporal prediction is derived from the previously encoded images, which are stored in a memory. The prediction signal using spatial prediction is derived from the values of boundary pixels in the neighboring blocks, which have been previously encoded, decoded, and stored in the memory. The difference e between the input signal and the prediction signal, denoted prediction error or residual, is transformed 110 resulting in coefficients, which are quantized 120. Entropy encoder 190 is then applied to the quantized coefficients in order to further reduce the amount of data to be stored and/or transmitted in a lossless way. This is mainly achieved by applying a code with code words of variable length wherein the length of a code word is chosen based on the probability of its occurrence.

Within the video encoder 100, a decoding unit is incorporated for obtaining a decoded (reconstructed) video signal s. In compliance with the encoding steps, the decoding steps include dequantization and inverse transformation 130. The so obtained prediction error signal e′ differs from the original prediction error signal due to the quantization error, called also quantization noise. A reconstructed image signal s′ is then obtained by adding 140 the decoded prediction error signal e′to the prediction signal ŝ. In order to maintain the compatibility between the encoder side and the decoder side, the prediction signal ŝ is obtained based on the encoded and subsequently decoded video signal which is known at both sides the encoder and the decoder.

Due to the quantization, quantization noise is superposed to the reconstructed video signal. Due to the block-wise coding, the superposed noise often has blocking characteristics, which result, in particular for strong quantization, in visible block boundaries in the decoded image. Such blocking artifacts have a negative effect upon human visual perception. In order to reduce these artifacts, a deblocking filter 150 is applied to every reconstructed image block. The deblocking filter is applied to the reconstructed signal s′. For instance, the deblocking filter of H.264/MPEG-4 AVC has the capability of local adaptation. In the case of a high degree of blocking noise, a strong (narrow-band) low pass filter is applied, whereas for a low degree of blocking noise, a weaker (broad-band) low pass filter is applied. The strength of the low pass filter is determined by the prediction signal ŝ and by the quantized prediction error signal e′. Deblocking filter generally smoothes the block edges leading to an improved subjective quality of the decoded images. Moreover, since the filtered part of an image is used for the motion compensated prediction of further images, the filtering also reduces the prediction errors, and thus enables improvement of coding efficiency.

After a deblocking filter, an adaptive loop filter 160 may be applied to the image including the already deblocked signal s″. Whereas the deblocking filter improves the subjective quality, ALF aims at improving the pixel-wise fidelity (“objective” quality). In particular, adaptive loop filter (ALF) is used to compensate image distortion caused by the compression. Typically, the adaptive loop filter is a Wiener filter with filter coefficients determined such that the mean square error (MSE) between the reconstructed s′ and source images s is minimized. The coefficients of ALF may be calculated and transmitted on a frame basis. ALF can be applied to the entire frame (image of the video sequence) or to local areas (blocks). An additional side information indicating which areas are to be filtered may be transmitted (block-based, frame-based or quadtree-based).

In order to be decoded, inter-encoded blocks require also storing the previously encoded and subsequently decoded portions of image(s) in the reference frame buffer 170. An inter-encoded block is predicted 180 by employing motion compensated prediction. First, a best-matching block is found for the current block within the previously encoded and decoded video frames by a motion estimator. The best-matching block then becomes a prediction signal and the relative displacement (motion) between the current block and its best match is then signalized as motion data in the form of three-dimensional motion vectors within the side information provided together with the encoded video data. The three dimensions consist of two spatial dimensions and one temporal dimension. In order to optimize the prediction accuracy, motion vectors may be determined with a spatial sub-pixel resolution e.g. half pixel or quarter pixel resolution. A motion vector with spatial sub-pixel resolution may point to a spatial position within an already decoded frame where no real pixel value is available, i.e. a sub-pixel position. Hence, spatial interpolation of such pixel values is needed in order to perform motion compensated prediction. This may be achieved by an interpolation filter (in FIG. 1 integrated within Prediction block 180).

For both, the intra- and the inter-encoding modes, the differences e between the current input signal and the prediction signal are transformed 110 and quantized 120, resulting in the quantized coefficients. Generally, an orthogonal transformation such as a two-dimensional discrete cosine transformation (DCT) or an integer version thereof is employed since it reduces the correlation of the natural video images efficiently. After the transformation, lower frequency components are usually more important for image quality then high frequency components so that more bits can be spent for coding the low frequency components than the high frequency components. In the entropy coder, the two-dimensional matrix of quantized coefficients is converted into a one-dimensional array. Typically, this conversion is performed by a so-called zig-zag scanning, which starts with the DC-coefficient in the upper left corner of the two-dimensional array and scans the two-dimensional array in a predetermined sequence ending with an AC coefficient in the lower right corner. As the energy is typically concentrated in the left upper part of the two-dimensional matrix of coefficients, corresponding to the lower frequencies, the zig-zag scanning results in an array where usually the last values are zero. This allows for efficient encoding using run-length codes as a part of/before the actual entropy coding.

The H.264/MPEG-4 H.264/MPEG-4 AVC as well as HEVC includes two functional layers, a Video Coding Layer (VCL) and a Network Abstraction Layer (NAL). The VCL provides the encoding functionality as briefly described above. The NAL encapsulates information elements into standardized units called NAL units according to their further application such as transmission over a channel or storing in storage. The information elements are, for instance, the encoded prediction error signal or other information necessary for the decoding of the video signal such as type of prediction, quantization parameter, motion vectors, etc. There are VCL NAL units containing the compressed video data and the related information, as well as non-VCL units encapsulating additional data such as parameter set relating to an entire video sequence, or a Supplemental Enhancement Information (SEI) providing additional information that can be used to improve the decoding performance.

FIG. 2 illustrates an example decoder 200 according to the H.264/MPEG-4 AVC or HEVC video coding standard. The encoded video signal (input signal to the decoder) first passes to entropy decoder 290, which decodes the quantized coefficients, the information elements necessary for decoding such as motion data, mode of prediction etc. The quantized coefficients are inversely scanned in order to obtain a two-dimensional matrix, which is then fed to inverse quantization and inverse transformation 230. After inverse quantization and inverse transformation 230, a decoded (quantized) prediction error signal e′ is obtained, which corresponds to the differences obtained by subtracting the prediction signal from the signal input to the encoder in the case no quantization noise is introduced and no error occurred.

The prediction signal is obtained from either a temporal or a spatial prediction 280. The decoded information elements usually further include the information necessary for the prediction such as prediction type in the case of intra-prediction and motion data in the case of motion compensated prediction. The quantized prediction error signal in the spatial domain is then added with an adder 240 to the prediction signal obtained either from the motion compensated prediction or intra-frame prediction 280. The reconstructed image s′ may be passed through a deblocking filter 250 and an adaptive loop filter 260 and the resulting decoded signal is stored in the memory 270 to be applied for temporal or spatial prediction of the following blocks/images.

As described above, the adaptive loop filter 260 is applied after the deblocking filter 250. The processing order when coding or decoding blocks of an image is typically sequential scan (starting from top left block and continuing by scanning the blocks in the first row, then starting with left-most block in the second row, etc. until the right bottom block. Deblocking filtering aims at reducing visibility of the block boundaries and is thus applied to the pixels of blocks near to the block boundaries. In particular, to filter a pixel of a current block, the taps of a deblocking filter are applied to signal of the current (filtered) block and to the pixels of its neighbouring block. Assuming the sequential scan, for a current block in an image, in general only the blocks to the left and on the top are available. In order to filter pixels of the current block in the proximity of the right or bottom block boundary it is therefore necessary to wait until the right and bottom neighbouring blocks are decoded and it is also necessary to store the pixels to be used for filtering in a so called line memory. Moreover, due to this delay, the application of the adaptive loop filter is also delayed since the adaptive loop filter is applied to an already deblocked signal. In order to apply the adaptive loop filter, the pixels necessary for such filtering are also to be temporarily stored in the line memory. A line memory is typically implemented as an on-chip (internal) memory in order to avoid memory access bandwidth problems. An on-chip memory has typically very limited size and it is thus essential to keep the amount of data to be temporarily stored therein as low as possible.

### SUMMARY OF THE INVENTION

Given these problems with the existing technology, it would be advantageous to provide an efficient filtering employing two cascaded filters which require storing of samples to be filtered and/or used for filtering such as a deblocking filter and an adaptive loop filter while reducing the amount of the required on-chip memory.

It is the particular approach of the present invention to apply a second filter to pixels which are to be processed by a first filter in such a way that at least one filter tap is applied to a pixel already processed by the first filter and the remaining filter taps are applied to pixels not processed by the first filter but to be processed by the first filter.

According to an aspect of the present invention, a method is provided for filtering a current block of an image by applying a first filter and a second filter, wherein the first filter is applied first and the second filter processes (applies its taps) the output of the first filter, the method comprising the steps of processing by the first filter predetermined pixels of current block by determining whether to apply the first filter and/or by applying the first filter to the predetermined pixels; and processing at least one pixel of the current block, which has already been considered by said first filter, with the second filter, wherein at least one tap of the second filter is applied to at least one of said predetermined pixels before application of said first filter.

According to another aspect of the present invention, an apparatus for filtering a current block of an image by applying a first filter and a second filter, wherein the first filter is applied first and the second filter is applied to the output of the first filter, the apparatus comprising: a first filtering unit for processing predetermined pixels of current block by judging whether to apply the first filter and/or by applying the first filter to the predetermined pixels; and a second filtering unit for processing at least one pixel of the current block, which has already been processed by said first filter, with the second filter, wherein at least one tap of the second filter is applied to at least one of said predetermined pixels before application of said first filter.

### BRIEF DESCRIPTION OF THE DRAWINGS

The accompanying drawings are incorporated into and form a part of a specification to illustrate several embodiments of the present invention. These drawings together with the description serve to explain the principles of the invention. The drawings are only for the purpose of illustrating preferred and alternative examples of how the invention can be made and used and are not to be construed as limiting the invention to only the illustrated and described embodiments. Further features and advantages will become apparent from the following and more particular description of the various embodiments of the invention, as illustrated in the accompanying drawings, in which like reference numbers refer to like elements and wherein:

FIG. 1 is a block diagram illustrating an example of a conventional video encoder;

FIG. 2 is a block diagram illustrating an example of a conventional video decoder;

FIG. 3 is a schematic drawing illustrating application of a deblocking filter;

FIG. 4 is a schematic drawing illustrating content of a line memory for application of deblocking filtering;

FIG. 5 is a schematic drawing illustrating content of a line memory for application of deblocking filtering and adaptive loop filtering;

FIG. 6 is a schematic drawing illustrating the requirements on number of lines to be stored in a line memory for application of deblocking filtering and adaptive loop filtering;

FIG. 7 is a block diagram illustrating an example of a video encoder modified in accordance with the present invention;

FIG. 8 is a block diagram illustrating an example of a video decoder modified in accordance with the present invention;

FIG. 9 is a schematic drawing illustrating adaptive loop filtering using undeblocked pixels;

FIG. 10 is a schematic drawing illustrating adaptive loop filtering using only horizontally deblocked pixels;

FIG. 11 is a schematic drawing illustrating adaptive loop filtering using only vertically deblocked pixels;

FIG. 12 is a schematic drawing illustrating adaptive loop filtering using both only vertically and only horizontally deblocked pixels;

FIG. 13 is schematic drawing illustrating adaptive loop filtering using undeblocked pixels and only horizontally deblocked pixels;

FIG. 14 is a schematic drawing illustrating adaptive partly deblocked pixels;

FIG. 15 is a schematic drawing illustrating the requirements on number of lines to be stored in a line memory for application of deblocking filtering and adaptive loop filtering in accordance with an embodiment of the present invention;

FIG. 16 is a schematic drawing illustrating the requirements on number of lines be stored in a line memory for application of deblocking filtering and adaptive loop filtering when padding is applied;

FIG. 17 is a flow diagram of a filtering method in accordance with an embodiment of the present invention;

FIG. 18 is a schematic drawing illustrating an overall configuration of a content providing system for implementing content distribution services;

FIG. 19 is a schematic drawing illustrating an overall configuration of a digital broadcasting system;

FIG. 20 is a block diagram illustrating an example of a configuration of a television;

FIG. 21 is a block diagram illustrating an example of a configuration of an information reproducing/recording unit that reads and writes information from or on a recording medium that is an optical disk;

FIG. 22 is a schematic drawing showing an example of a configuration of a recording medium that is an optical disk;

FIG. 23A is a schematic drawing illustrating an example of a cellular phone;

FIG. 23B is a block diagram showing an example of a configuration of the cellular phone;

FIG. 24 is a schematic drawing showing a structure of multiplexed data;

FIG. 25 is a drawing schematically illustrating how each of the streams is multiplexed in multiplexed data;

FIG. 26 is a schematic drawing illustrating how a video stream is stored in a stream of PES packets in more detail;

FIG. 27 is a schematic drawing showing a structure of TS packets and source packets in the multiplexed data;

FIG. 28 is a schematic drawing showing a data structure of a PMT;

FIG. 29 is a schematic drawing showing an internal structure of multiplexed data information;

FIG. 30 is a schematic drawing showing an internal structure of stream attribute information;

FIG. 31 is a schematic drawing showing steps for identifying video data;

FIG. 32 is a schematic block diagram illustrating an example of a configuration of an integrated circuit for implementing the video coding method and the video decoding method according to each of embodiments;

FIG. 33 is a schematic drawing showing a configuration for switching between driving frequencies;

FIG. 34 is a schematic drawing showing steps for identifying video data and switching between driving frequencies;

FIG. 35 is a schematic drawing showing an example of a look-up table in which the standards of video data are associated with the driving frequencies;

FIG. 36A is a schematic drawing showing an example of a configuration for sharing a module of a signal processing unit;

FIG. 36B is a schematic drawing showing another example of a configuration for sharing a module of a signal processing unit; and

FIG. 37 illustrates another particular example of applying a method according to the present invention.

### DETAILED DESCRIPTION OF THE INVENTION

The problem underlying the present invention is based on the observation that application of deblocking filter and adaptive loop filter increases requirements on the on-chip line memory.

New features of video encoders enable a high level of scalability and provide various advanced features for improving the image quality. Such features are, for instance, deblocking filtering and adaptive loop filtering applied one after another. Such filters use for filtering the current data and a portion of previously encoded and/or decoded data. Thus, the previously encoded/decoded data has to be stored temporarily in a memory for future use. Typically, a hardware implementation of the encoder and decoder usually employs on-chip memories in order to reduce the external memory bandwidth requirements. Usually, the data that is to be used multiple times during the encoding/decoding process is therefore stored in the on-chip memory. As a result, it is avoided to employ external memory which, on the other hand, enables to reduce external memory access requirements. For employment of the in-loop deblocking filter and adaptive loop filter, there is a particular type of on-chip memory called line memory, which is used to store temporarily the pixels to be used later. The name “line memory” is selected since typically, lines of pixels are stored therein. In particular, there is usually a horizontal line memory and a vertical line memory. The horizontal line memory typically stores a row or a plurality of rows of pixels from an image (video frame). The vertical memory typically stores a column or a plurality of columns of pixels from a block, for instance, the largest coding unit (LCU).

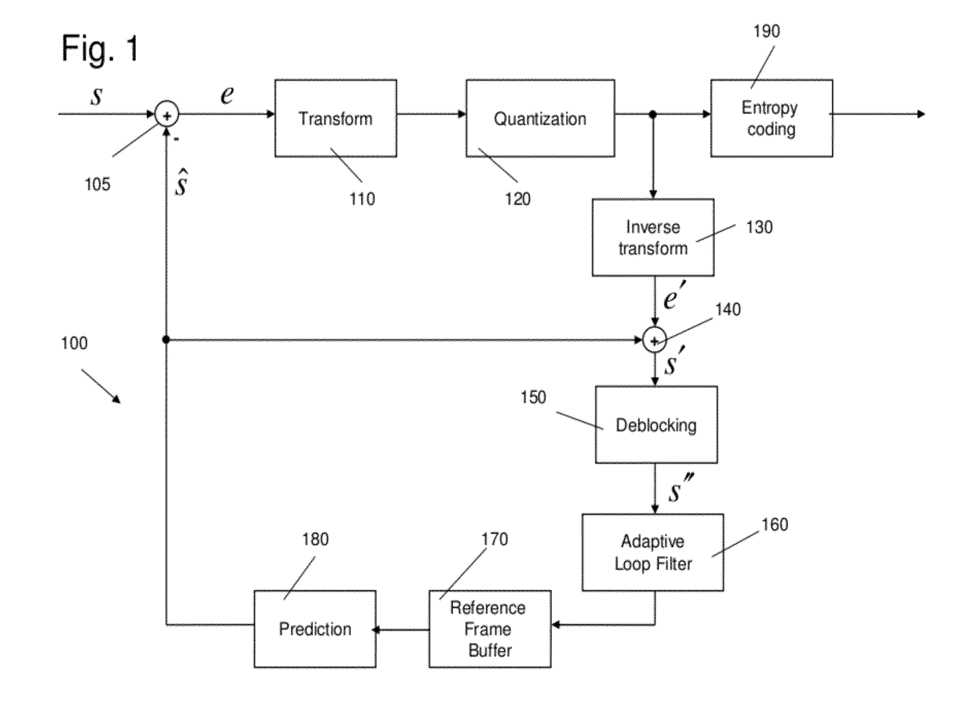

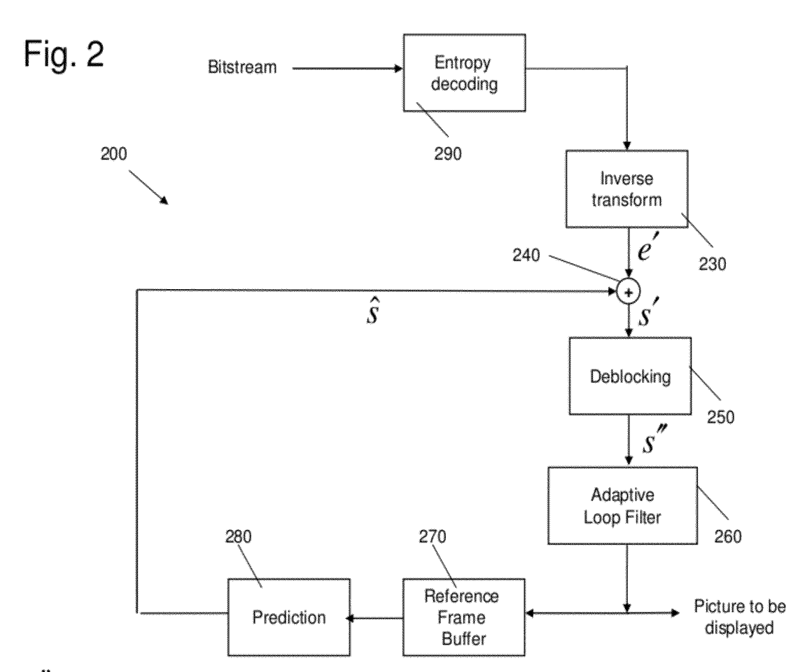

The present invention is applicable to the encoder 100 and/or to the decoder 200 side. At the encoder, the present invention is applicable to the loop, which is a part on a decoding unit within the encoder since it processes the reconstructed signal It is noted that the present invention is also applicable to an encoder and/or decoder similar to those in FIGS. 1 and 2, but differing from them in that the order of applying deblocking and adaptive loop filtering is exchanged, i.e., the adaptive loop filter is applied first and the deblocking filter is applied to the output of the adaptive loop filter.

In the following, an example is provided, in which the present application is applied to a deblocking filter as a first filter and to an adaptive loop filter as a second filter. However, as is clear for those skilled in the art, the present invention is applicable also to the exchanged order, and also to different kind of filters, for instance, the filters need not be necessarily loop filters. The present invention enables achieving reduction of memory requirements at the decoder side and thus, may be applied to any cascaded filter which require storage of pixels for filtering, in particular, storing lines (rows or columns) of pixels in the on-chip memory.

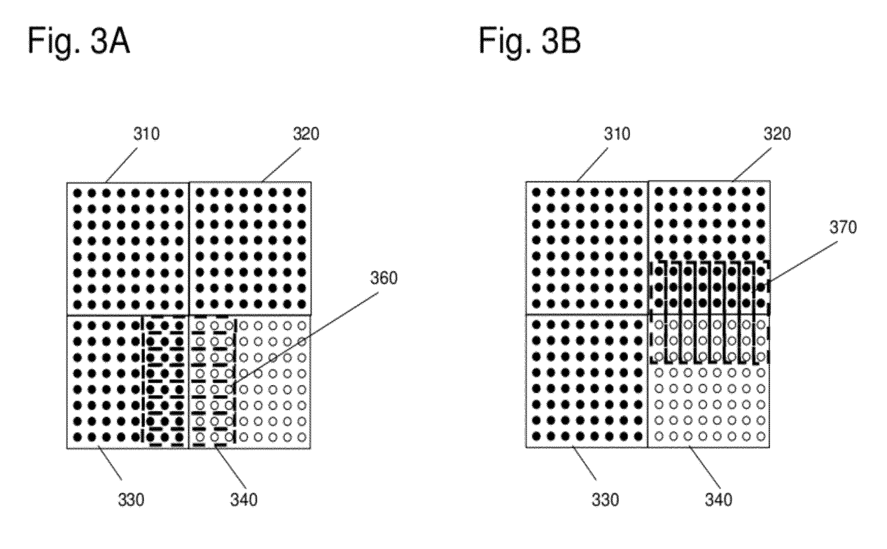

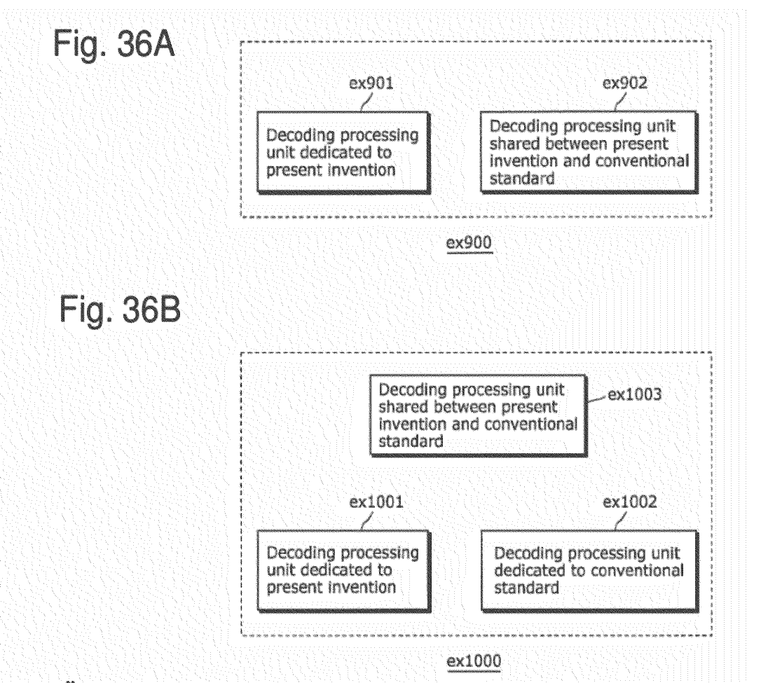

FIG. 3 shows an example of an application of a deblocking filter such as 150 and 250 referred to in the description of FIGS. 1 and 2, respectively. Such a deblocking filter may decide for each sample at a block boundary whether it is to be filtered or not. When it is to be filtered, a low pass filter is applied. The aim of this decision is to filter only those samples, for which the large signal change at the block boundary results from the quantization applied in the block-wise processing as described in the background art section above. The result of this filtering is a smoothed signal at the block boundary. The smoothed signal is less annoying to the viewer than the blocking artifact. Those samples, for which the large signal change at the block boundary belongs to the original signal to be coded, should not be filtered in order to keep high frequencies and thus the visual sharpness. In the case of wrong decisions, the image is either unnecessarily smoothened or remains blocky. FIG. 3A illustrates decision on a vertical boundary (to filter or not to filter with a horizontal deblocking filter) and FIG. 36 illustrates decision on a horizontal boundary (to filter or not with a vertical deblocking filter). In particular, FIG. 3A shows a current block 340 to be decoded and its already decoded neighbouring blocks 310, 320, and 330. For the pixels 360 in a line, the decision is performed. Similarly, FIG. 3B shows the same current block 340 and decision performed for the pixels 370 in a column. The judgment on whether to apply the deblocking filter may be performed as follows.

Let us take a line of 6 pixels 360, the first three pixels p2, p1, p0 of which belong to left neighbouring block 330 and the following three pixels q0, q1, and q2 of which belong to the current block 340. Pixels p0 and q0 are the pixels of the left neighbour and of the current block, respectively, located directly adjacent to each other. Pixels p0 and q0 are filtered by the deblocking filtered for instance, when the following conditions are fulfilled:

|p₀-q₀|<α(QP+Offset_{A}),

|p₀-p₀|<β(QP+Offset_{B}), and

|q₁-q₀|<β(QP+Offset_{B}), wherein, for instance, β<α. These conditions aim at detecting whether the difference between p0 and q0 stems from blocking artifacts. Pixel p1 is filtered, for instance, if in addition to the above three conditions also the following condition is fulfilled: |p₂-p₀|<β(QP+Offset_{B}). Pixel q1 is filtered, for instance, if in addition to the above first three conditions also the following condition is fulfilled: |q₂-q₀|<β(QP+Offset_{B}). In the above conditions, QP denotes quantization parameter indicating the amount of quantization applied, β, α are scalar constants and Offset_{A}, Offset_{B} denote slice level offsets. The slice level offsets are encoder-selectable offsets that can be used to increase or decrease the amount of filtering that takes place compared to filtering with default zero offsets. The decision may be performed only for selected line or lines of a block, while the filtering of pixels accordingly is then performed for all lines 360.

Another example of deblocking filtering in HEVC can be found in JCTVC-D503 document, section 8.6.1, of JTC-VC, of ITU-T SG16 WP3 and ISO/IEC JTC1/SC29/WG11, freely available under http://wftp3.itu.int/av-arch/jctvc-site/2011_{—}01_D_Daegu/.

However, the present invention may work irrespectively of particularities of the deblocking filter. The deblocking filter may also be fixedly applied to a predefined number of pixels in a line (row or column) at a block boundary so that no decision is necessary. The deblocking filter may be, for instance, a filter with a predefined number of taps such as 3, 4, 5, however, other sizes are also applicable, such as 5, 6, 7, 8 etc. The number of taps may depend on the position of pixel to be deblocked. The actual length of the deblocking filter is immaterial to the present invention, which can work with any such size.

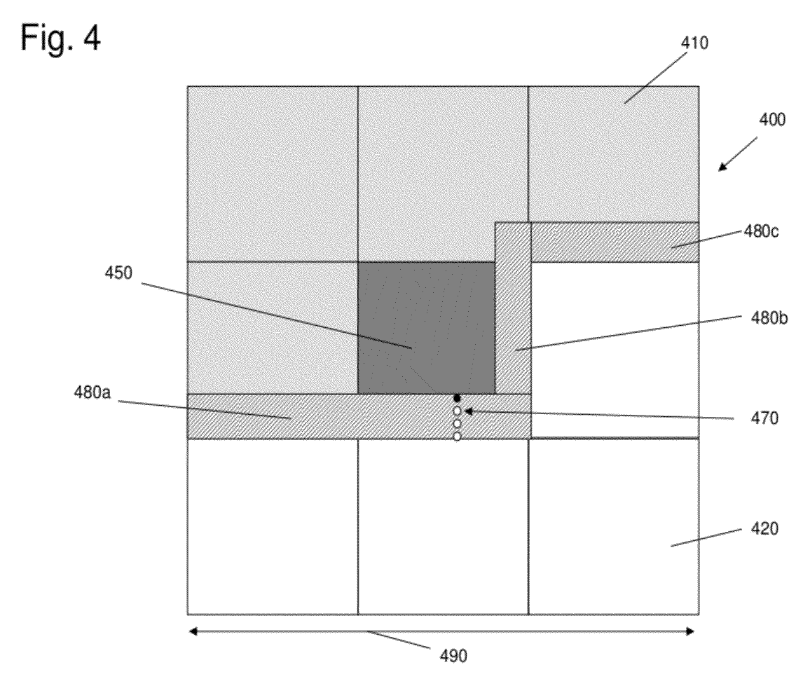

An example of content of such a line memory required for deblocking filtering is schematically illustrated in FIG. 4. FIG. 4 shows an image frame 400 with a frame width 490 including nine blocks. A block in the middle is the current block 450 which is currently being encoded and/or decoded. It is assumed that the encoding and/or decoding takes place in a raster (successive) scan order which means that the upper and left blocks 410 are already encoded and/or decoded. The remaining blocks 420 are not decoded yet at the time at which the current block 450 is being encoded and/or decoded and are thus not yet available for filtering. Since the bottom and right blocks 420 are still not available, deblocking cannot be performed on the top and on the right boundary of the current block. Since the immediate neighbours of the currently decoded block 450 are still not available, the filtering operations using their pixels have to be delayed. The samples (pixels) 480 that are required for the delayed filtering later are thus temporarily stored in the line memory. Samples 480a and 480c are stored in a horizontal line memory until they can be vertically filtered by a deblocking filter. Samples 480b are stored in the vertical line memory until they can be horizontally filtered by the deblocking filer.

In particular, FIG. 4 illustrates an example in which the deblocking filter requires storing four lines of pixels 470. In particular, the three pixels (illustrated as white dots) closest to the current block boundary may be modified by the deblocking filter (may be modified). The fourth line may be applies a tap of the deblocking filter during filtering of other pixels, however, it is not modified by the filtering.

The adaptive loop filter may be, for instance, a diamond-formed filter with 5, 7, or 9 taps. However, the present invention is not limited to such a kind of filter and the shape and/or the size of the adaptive loop filter may be selected differently for the purpose of the present invention. Taps correspond to the positions of filter coefficients to be applied to the filtered signal. ALF may be carried out on a per fame, basis, which requires storing of an entire deblocked image in the frame buffer memory 170, 270. This, however, requires additional external memory bandwidth. Alternatively, ALF may be applied on a block basis, for instance, per LCU. In such a case, depending on the size of the ALF, lines of pixels used for ALF filtering must be stored in a line buffer.

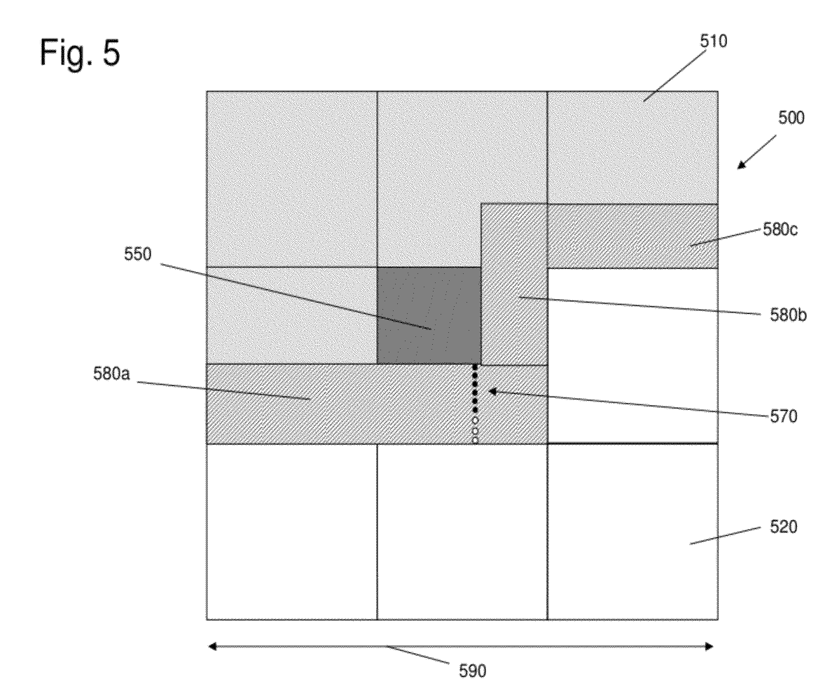

FIG. 5 illustrates the line memory requirements when deblocking filter and adaptive loop filter are both applied. Frame 500 with a frame width 590 includes nine blocks, four of which 510 are already decoded and one, the current block 550, is being decoded. The remaining blocks 520 are not yet decoded. In this example it is assumed that the adaptive loop filter has a vertical size of seven taps, in addition to the deblocking filter. Consequently, in addition to situation illustrated in FIG. 4, six more lines are required to be stored in the line buffer. In particular, the four lowest pixels (closest to the bottom boundary of the current block) from among pixels 570 are required by the deblocking filter, similarly to FIG. 4. Three lowest of these four pixels may also be modified by the deblocking filter (illustrated as white dots in FIG. 5). Assuming the size of ALF with 7 taps, further 6 lines are necessary to be stored when one line is shared with those required for the deblocking filter. The corresponding content of the line memory is illustrated by the shaded area 580, in particular, horizontal line memory 480a and 480c, and vertical memory 480b. In order to improve the performance, it is particularly interesting to reduce the size of the horizontal memory, since it is larger than the vertical line memory.

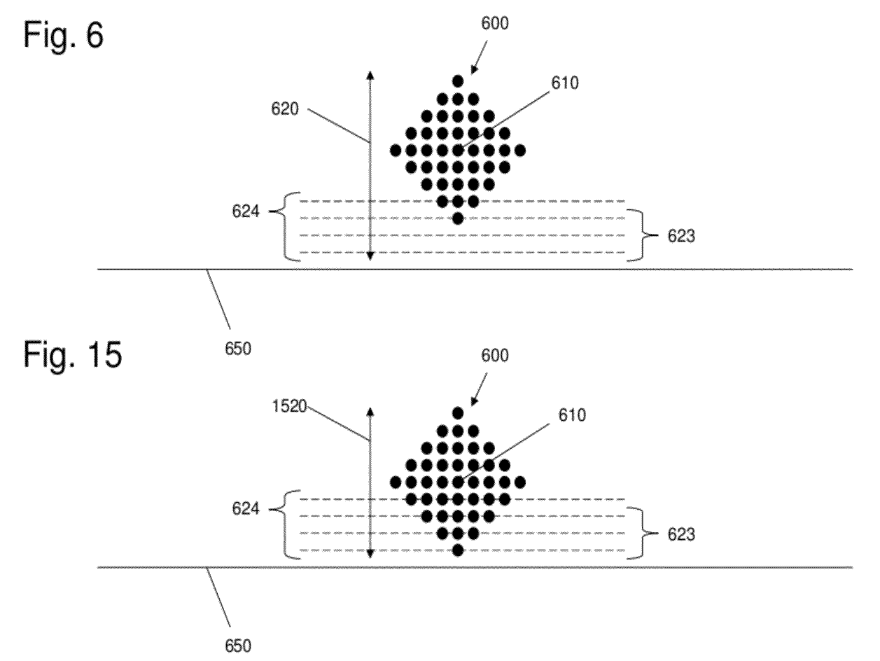

An example of an adaptive loop filter in HEVC can be found in JCTVC-D503 document, section 8.6.2, of JTC-VC, of ITU-T SG16 WP3 and ISO/IEC JTC1/SC29/WG11, freely available under http://wftp3.itu.int/av-arch/jctvc-site/2011_{—}01_D_Daegu/._FIG. 6 illustrates line memory requirements for deblocking and adaptive loop filtering. The adaptive loop filter 600 has a diamond-shaped form and size of 9 taps. The filter taps are illustrated in FIG. 6 as black dots, the central tap 610 being applied to the pixel which is actually filtered (modified). Adaptive loop filter should be applied after deblocking which means to the already deblocked signal. The deblocking filter assumed in previous examples requires four lines 624 to be stored in the line memory. Three of them, namely the lowest three lines 623, shall be modified by the deblocking filter and therefore, cannot be used by the ALF immediately but first when the bottom block (under the border 650) is available. Thus, the adaptive loop filter requires for filtering eight further lines. One line is shared by both filters, this is the highest line which is used by the deblocking filter but not modified thereby. Consequently, in total, eleven lines 620 are required to be stored in the on-chip memory.

In general, the amount of horizontal line memory required for the decoding may be estimated as a product of frame width in pixels, internal pixel bit-depth, and the number of lines (rows) necessary. Similarly, the amount of vertical line memory required for decoding may be estimated as a product of LCU height, internal pixel bit-depth, and the number of lines (columns) necessary.

The number of lines necessary depends on the employed deblocking and adaptive loop filtering, in particular on their respective vertical and horizontal size. The number of lines equals the number of lines necessary for deblocking filtering +number of lines of vertical adaptive loop filter −2. Since the adaptive loop filter is applied on the already deblocked frame, additional horizontal line memory is required for the adaptive loop filter which is directly proportional to the vertical size of the filter. For the example illustrated in FIG. 5, the horizontal line memory M necessary (in bits) is given by:

M=frame_width.pixel_bit_depth.(4+ALF_size −2), wherein the pixel bit-depth is number of bits per pixel. In particular, it is the number of bits per pixel used by the implementation of the encoder and/or decoder. ALF_size is vertical size of the ALF 600, which is 9 according to the example. Number four corresponds to 3 pixels modified by the deblocking filter and one pixel used by it, but not modified.

Since the line memory implies additional costs in the chip production, it is important to reduce the size of the line memory which in turn enables reduction on the on-chip memory bandwidth.

There still may be pixels that are considered by the deblocking filter and the values of which are not modified. There are also pixels within the frame which are never modified considering a particular definition of deblocking operation as described with reference to FIG. 3. However, the present invention is not limited thereto and may be employed irrespectively of the particular deblocking filter size. In the following the term “deblocked signal” denotes the signal which is already considered (accessed, and possibly modified) by the deblocking filter. The term “un-deblocked signal”, on the other hand, shall denote signal which has not yet been considered by the deblocking filter.

In accordance with the present invention, in order to reduce the number of lines in the line memory, the second filtering is made flexible in terms of the input signal to be used for such filtering. Instead of delaying the second, the unavailable pixels (which should be processed by the first filter) are replaced, for the purpose of the second filtering, with the pixels not yet or partially processed with the first filter as will be illustrated in the following examples. It is noted that the present invention is applicable to both, or to either of horizontal and vertical line memory.

Accordingly, a method is provided for filtering a current block of an image by applying a first filter and a second filter, wherein the first filter is applied first and the second filter is applied to an output of the first filter, the method comprising the steps of processing by the first filter predetermined pixels of current block by applying the first filter to the predetermined pixels and/or by judging whether to apply the first filter to the predetermined pixels; and processing at least one pixel of the current block, which has already been processed by said first filter, with the second filter, wherein at least one tap of the second filter is applied to at least one of said predetermined pixels before processing by said first filter. The judging may be for instance determining whether the predetermined pixels are to be deblocked at all due to their location. Thus, if a pixel is located far from the block boundary, no deblocking filter is necessary. It may also judge the pixels at the block boundaries to decide whether deblocking is needed.

The partially deblocked pixels said at least one predetermined pixel may be a pixel processed only by vertical or only by horizontal component of the first filter and still to be processed with a horizontal of a vertical component of the first filter, respectively. Said at least one predetermined pixel may be a pixel to which the first filter was not applied. Alternatively, or in addition, said at least one predetermined pixel is replaced for the filtering with the second filter with pixels from a different line in the current block, saved in a memory.

The method may further comprise a judging step for judging whether the second filter is to be applied to the predetermined pixels and for providing an indicator for indicating the result of the judging step. Moreover, the method may further comprise a judging step for deciding at least one of applying said at least one tap of the adaptive loop filter to deblocked, undeblocked, or partly deblocked pixels from either same pixel position or different pixel position within the current block.

The above described method may be employed for encoding or decoding of video. In particular, a method may be provided for encoding of a video signal including the steps of: reconstructing a coded image signal with a decoding unit, and filtering the reconstructed image signal by the above described method.

In accordance with another embodiment of the present invention, a computer program product is provided comprising a computer-readable medium having a computer-readable program code embodied thereon, the program code being adapted to carry out the method as described above.

According to the present invention, an apparatus may be provided for filtering a current block of an image by applying a first filter and a second filter, wherein the first filter is applied first and the second filter is applied to the output of the first filter, the apparatus comprising: a first filtering unit for processing predetermined pixels of current block by judging whether to apply the first filter and/or by applying the first filter to the predetermined pixels; and a second filtering unit for processing at least one pixel of the current block, which has already been processed by said first filter, with the second filter, wherein at least one tap of the second filter is applied to at least one of said predetermined pixels before application of said first filter.

Such an apparatus may be a part of an encoder or decoder, which may further comprise a decoding unit for reconstructing a coded image signal. The apparatus may be embodied on a chip further comprising a memory, which is a vertical and/or horizontal line memory for storing pixels to be filtered.

In accordance with an embodiment of the present invention, in order to reduce the number of lines in the line memory, the adaptive loop filtering is made flexible in terms of the input signal to be used for the filtering. Instead of delaying the adaptive loop filtering, the unavailable deblocked pixels are replaced, for the purpose of the adaptive loop filtering, with the un-deblocked or partially deblocked pixels as will be illustrated in the following examples. It is noted that the present invention is applicable to both, or to either of horizontal and vertical line memory.

Partially deblocked pixels (half-deblocked pixels) are those pixels, which are deblocked only horizontally or only vertically, meaning that they are processed only with a vertical or a horizontal component of the deblocking filter. This maybe the case, for instance, for two-dimensional separable deblocking filter.

In the examples above, an individual pixel is filtered by applying adaptive loop filter to it the central tap 610 of the filter 600 and by applying the remaining filter taps to other pixel positions within the current block or within the neighbouring depending on the size of the two-dimensional filter that is applied. According to an embodiment of the present invention, the center tap of the filter is restricted to use only the pixels that are already processed by the deblocking filter. This guarantees that the sequential order of deblocking filtering as first and adaptive loop filtering as second is kept the same. However, the filter taps surrounding the central tap can be applied to deblocked, un-deblocked, or partially deblocked signals in order to reduce the line memory requirement. The requirement of keeping the sequence (order) of filter application with deblocking filter first is fulfilled in the above examples by applying the central tap of the adaptive loop filter to an already deblocked pixel. However, this is only the case for the above examples with symmetrical two dimensional filter having such a central tap. In general, the requirement is fulfilled when the filtered current pixel (the pixel to be modified by the adaptive loop filter) is already deblocked. The other pixels used in filtering of the current pixel (pixels to which other taps are applied) may be deblocked, un-deblocked or partially deblocked.

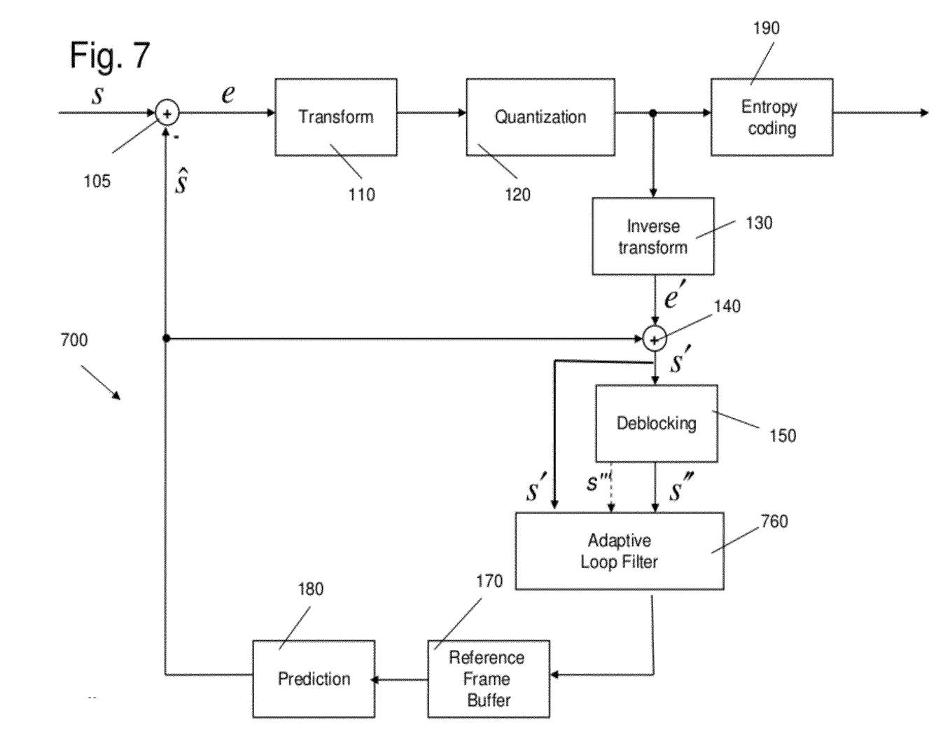

FIG. 7 illustrates modified video encoder 700 in accordance with the present invention. In particular, in addition to the encoder described with reference to FIG. 1, the reconstructed signal s′ is provided to the adaptive loop filter 760 directly without deblocking. Alternatively, or in addition, partially deblocked signal s′″ is provided to the adaptive loop filter after partial (for instance vertical only or horizontal only) deblocking. Accordingly, the filter taps surrounding the central tap can be applied to the input signal which is not deblocked or only deblocked partially.

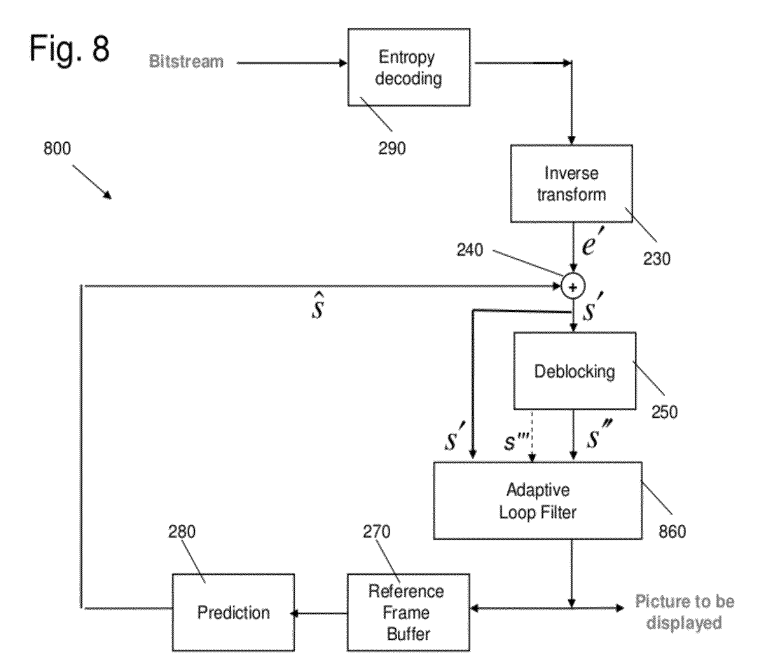

FIG. 8 illustrates modified video decoder 800 in accordance with the present invention. In particular, in addition to the decoder described with reference to FIG. 2, the reconstructed signal s′ is provided to the adaptive loop filter 860 directly without deblocking. Alternatively, or in addition, partially deblocked signal s′″ is provided to the adaptive loop filter after partial (for instance vertical only or horizontal only) deblocking. Accordingly, the filter taps surrounding the central tap can be applied to the input signal which is not deblocked or only deblocked partly.

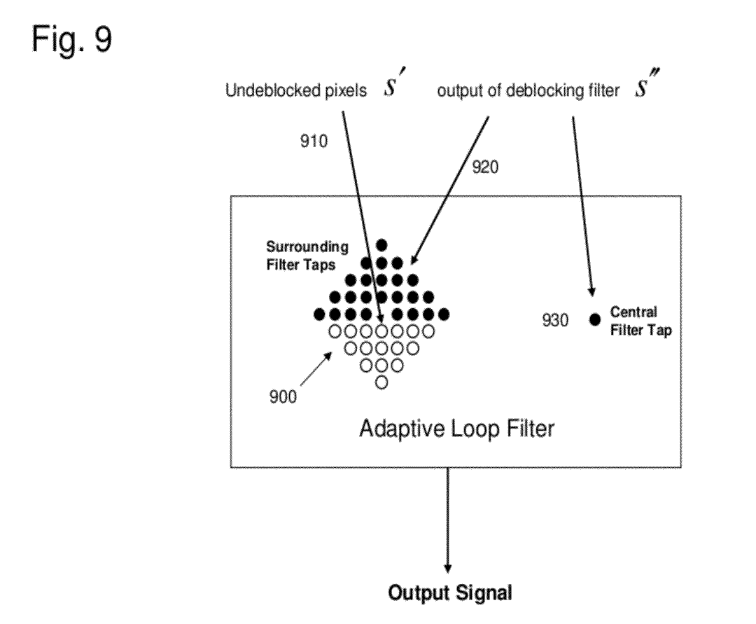

FIG. 9 illustrates such an adaptive loop filtering using undeblocked pixels. The undeblocked pixels are the pixels reconstructed but not (yet) deblocked. As can be seen in FIG. 9, the two-dimensional diamond-shaped filter is applied to a deblocked signal 920 and to undeblocked signal 910. The central filter tap 930 is shown separately as it is restricted to be applied to the pixels that are processed already by the deblocking filter. Thus, the filtering order of the first deblocking filter and then adaptive loop filter is not changed. The undeblocked pixels 910 shown in the FIG. 9 are only an example. The region covered by these pixels is dependent on the availability of the deblocked pixels which in general depends on the position of the center filter tap applied within the image, in particular on the proximity to the block boundaries. By using the undeblocked pixels the number of line memory lines is reduced.

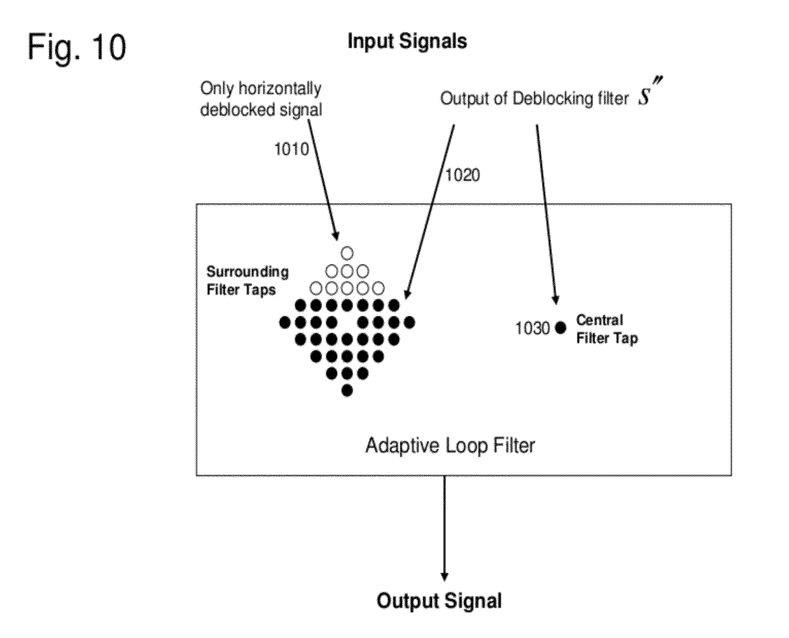

FIG. 10 illustrates adaptive loop filtering which instead of using unavailable deblocked signal uses partially deblocked signal, in particular, horizontally deblocked signal 1010. Similarly to the previous case (cf. FIG. 9), the central filter tap 1030 has always to be applied to already deblocked data and the remaining taps are applied either to the horizontally deblocked signals 1010 or completely deblocked signals 1020, where available.

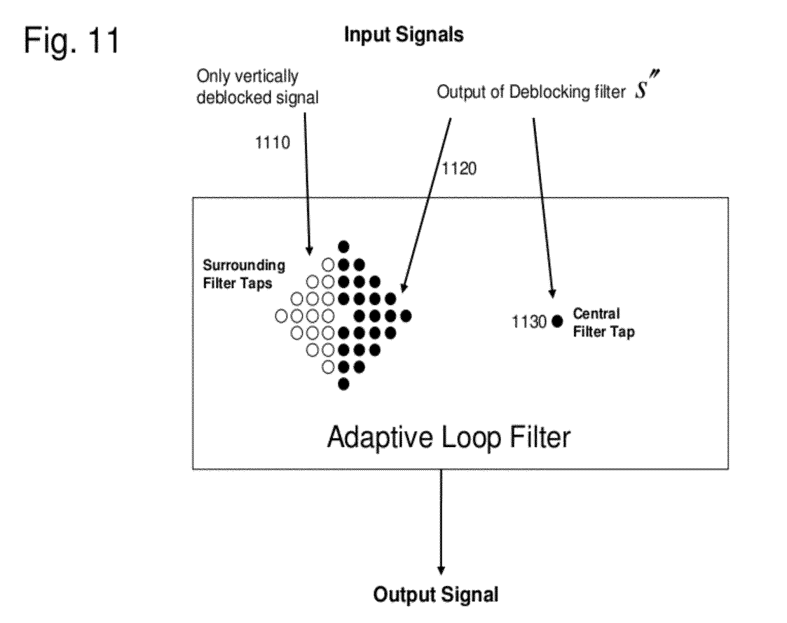

Another example is illustrated in FIG. 11. The adaptive loop filtering differs from the adaptive filtering described with reference to FIG. 10 in that the filter 900 is applied to the input signal including only vertically deblocked signal 1110 and completely deblocked signal 1120. Signal here, refers to a pixel or pixels.

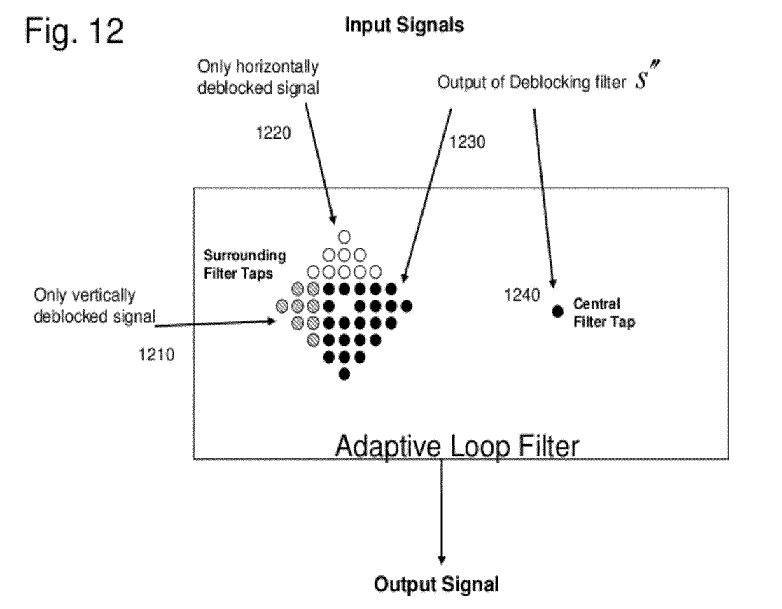

FIG. 12 shows a combination of approaches illustrated in FIGS. 10 and 11, namely it applies adaptive loop filter to only horizontally deblocked signal 1220, only vertically deblocked signal 1210, and completely deblocked signal 1230 wherein the pixel filtered by the center filter tap 1240 is also already deblocked.

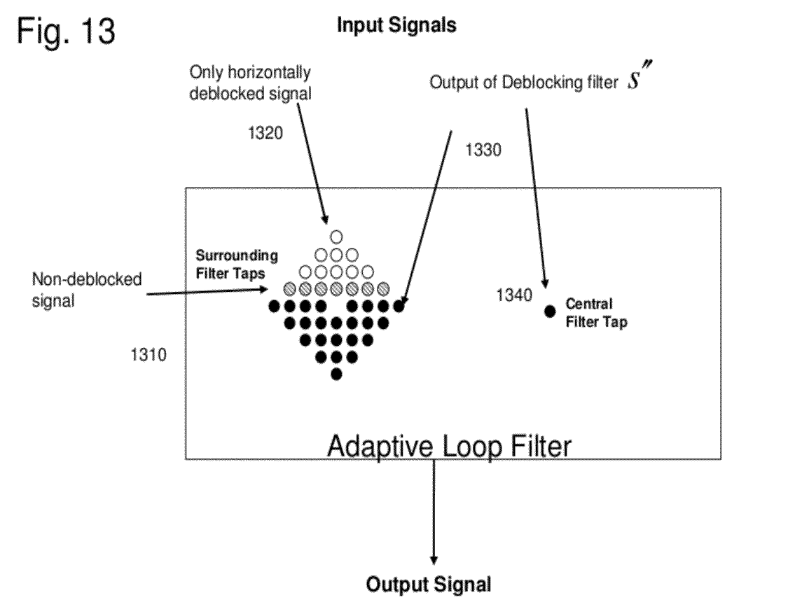

FIG. 13 illustrates another example of employing the present invention. In particular, adaptive loop filter is applied with its central filter tap to an already deblocked signal 1340. Moreover, the filter is applied to already deblocked signal points 1330, to only horizontally deblocked signal points 1320 and to undeblocked signal 1310.

As is clear for a person skilled in the art, any combination of input signal points of deblocked, undeblocked, and/or partially deblocked (only horizontally deblocked or only vertically deblocked) signal is applicable for the present invention.

In general, it would be beneficial to reduce the memory requirements at the decoder side since it is more critical. This is because especially in broadcast, streamed or stored video content is encoded once, possibly on a system without real-time requirements, and then provided to terminals, which may be power and/or computational power limited.

It is an advantage of the present invention, that it reduces the complexity of the decoder by reducing the requirements on its on-chip line memory.

Regarding the encoder, its complexity may also slightly increase in order to achieve the reduction of line memory at the decoder side. The reason is: The encoder now might need to store additional signals (non- or partially deblocked signals) in addition to the deblocked signals. To be more precise the need to store the deblocked signal in the encoder depends highly on the choice of implementation style. The deblocked signal might need to be stored in the encoder side, since usually the design procedure of the Adaptive Loop Filter might require several refinement steps where in each refinement step all or the parts of the deblocked frame might need to be accessed.

To overcome this problem two additional alternative solutions are proposed to increase the flexibility of the encoder. First Alternative: The encoder may, when it decides not to take the additional burden of storing more signals, signal a flag to the decoder. The flag may indicate that in the regions where non-deblocked (undeblocked) pixels are required by ALF, ALF is not applied. The signalling may be performed on a per slice/frame basis or via an extra message, or on a block basis, etc. This solution provides an advantage of reducing the storage requirements on the decoder while reducing the additional burden on the encoder.

Second Alternative: The encoder may, when it decides not to take the additional burden of storing more signals, signal a flag to the decoder. The flag may indicate that a padding operation is applied to avoid usage of non-deblocked pixels. Instead of non-deblocked pixels at given position, any other signal that is already available is used (for instance, undeblocked signal from other positions as will be illustrated below in more detail). The proposed two additional solutions may lead to a reduction of the compression performance. However, they enable the encoder to flexibly decide whether or not the present invention is to be used, an which of its embodiments.

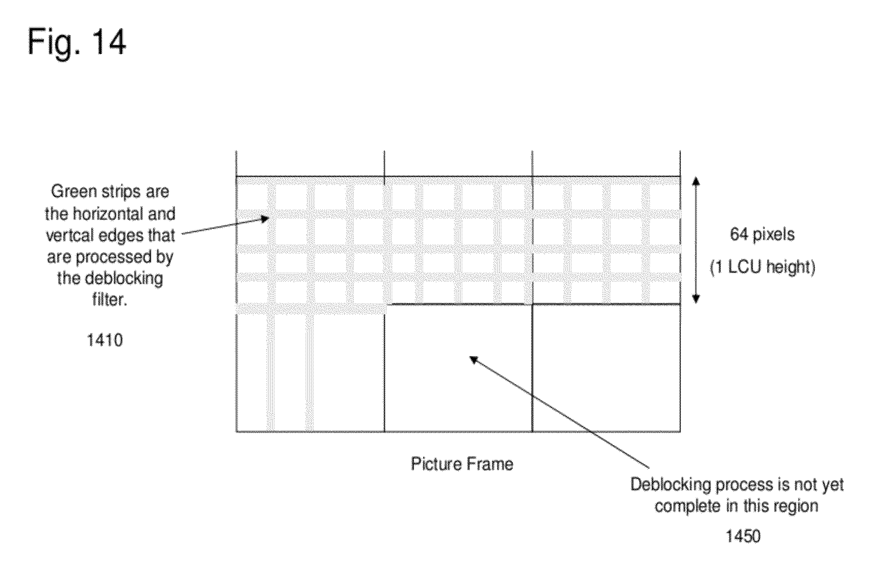

Regarding the partly deblocked signal, FIG. 14 illustrates a picture frame with the largest coding unit (for instance with a size of 64 pixels). Block 1450 is the current block to be decoded and gray stripes show horizontal and vertical edges that are processed (are to be considered) by the deblocking filter 1410. Deblocking process takes place according to a predefined order. Vertical and horizontal edges are filtered one by one. A partially deblocked signal (frame) is a frame where the deblocking process is not fully completed as, for instance, in the lower three blocks in the figure.

FIG. 15 shows a similar example as FIG. 6, however, in this case the filtering in accordance with one of the embodiments of the present invention described above is applied. The same filter mask 600 is applied to the image signal. In the example of FIG. 6, the outer most lines 623 are to be modified later. This causes delay of the adaptive loop filtering. According to the present invention the input type of the signal to be filtered is switched in the proximity of the coding unit (block) border. This means that adaptive loop filtering uses the last three lines although there are not yet deblocked. There is no change in the order of deblocking and adaptive loop filtering since adaptive loop filter does not modify the last three lines 623. Accordingly, four lines are shared between deblocking filter and adaptive loop filter. Therefore, in total, eight lines in the line memory are required to be stored. In contrast, the example described in reference to FIG. 6 needed to store eleven lines.

Formula for computing the required number of line memory with the proposed scheme is

Horizontal line memory in number of lines=Vertical length of the Adaptive Loop Filter −1

In the case of vertical line memory (at the vertical block borders):

Vertical line memory in number of lines=Horizontal length of the Adaptive Loop Filter −1

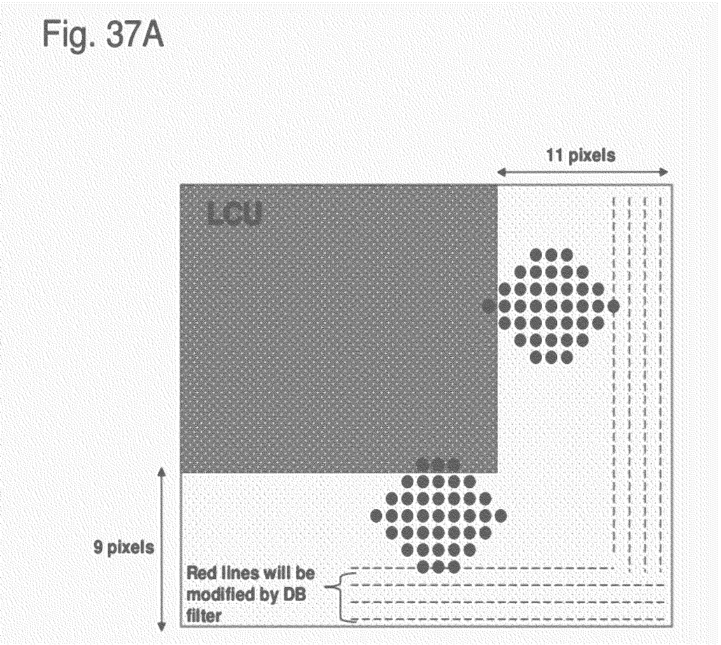

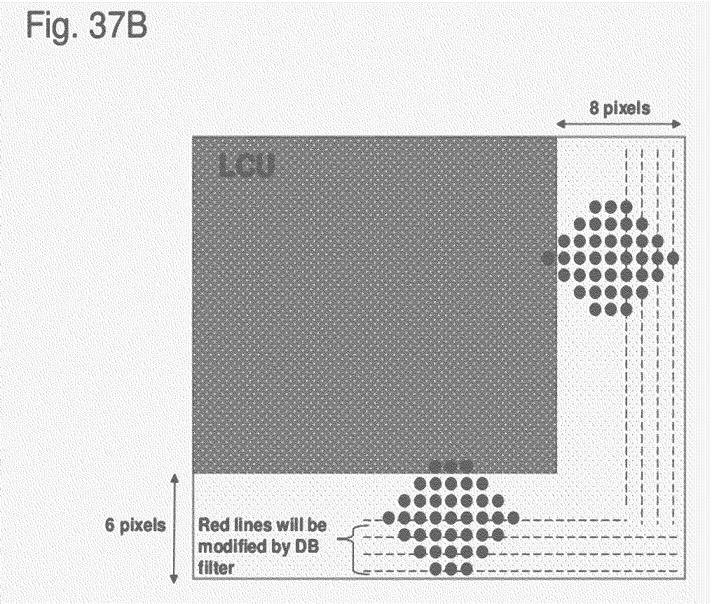

Another particular example of the present invention is illustrated in FIG. 37A and relates to development of current HEVC codec. The region that needs to be stored in the line memory is composed of 9 horizontal lines. Due to the fact that the lowermost 3 lines might be modified by deblocking filter, the ALF filter is deferred additionally by 3 lines. The ALF filter is shown in the lowermost position where the filtering process can be carried out. Below that point, since ALF will have filtering taps that overlap with the lines to be modified later by deblocking filter, the filtering operation cannot be applied. FIG. 37B shows the proposed filtering operation at the horizontal LCU borders. Here it is proposed that ALF uses partially deblocked pixels at the LCU border in order to avoid additional delay in filtering operation. In other words, although the 3 lines at the block edge are going to be modified by the deblocking filter, ALF is allowed to use these pixels as input. Therefore additional delay that is caused by the sequential order of the filters is eliminated, reducing the line memory requirement to 6 lines.

The proposed method does not change the order of the deblocking filter and ALF. With the proposed technique ALF is allowed to use the available partially (half-) deblocked pixels at the horizontal LCU block borders where deblocking filter has to be delayed. The inventive approach may also be applied to the chrominance component. Here the maximum vertical size of the ALF filter could be 5 and only one horizontal line is modified by deblocking filter at LCU borders.

The horizontal line memory accounts for most of the memory that is needed to be implemented (The size of the line memory is directly proportional to the width of the frame). However the above technique can be applied to reduce the vertical line memory as well as also illustrated in FIGS. 37A and 37B. It is also possible to extend the approach to include the reduction in the vertical line memory as well, or it is also possible to employ the approcha only for the vertical line memory. FIG. 37B shows that this embodiment of the present invention enables reducing of vertical line memory from 11 lines to 8 lines.

Similarly to the horizontal case, the vertical line memory reduction may also be applied to the chroma component. Therefore the vertical line memory required for chroma filtering may also be reduced from 5 to 4.

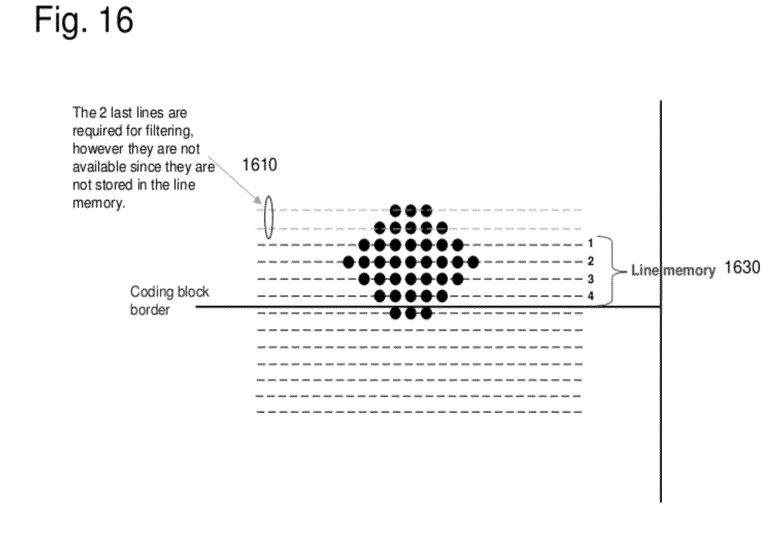

In accordance with another embodiment of the present invention, the line memory is even more reduced by not storing a predefined number of lines in the line memory even if they are required for adaptive loop filtering and by replacing them with deblocked, undeblocked, or partially deblocked pixels from different pixel positions. This is illustrated in FIG. 16. Two lines 1610 are required for filtering. However, they are unavailable since they are not stored in the line memory. In the line memory, only the four lines 1620 are stored. The two lines 1610 may be then substituted with pixels from other positions that are already pre-processed by the deblocking filter. Since the current filtering order is the deblocking filter first, the pixels stored in the line memory are already deblocked. Then the stored pixels are used for padding the missing (non-stored) two lines 1610 and as an input to the adaptive loop filter. However, the padding of the missing lines 1610 may also be performed with half deblocked or undeblocked pixels. When avoiding the delay caused by waiting for deblocking the pixels before ALF, the lines in the line memory are either undeblocked or partially deblocked. Therefore, accessing the undeblocked or partly deblocked pixels to be used for padding is possible. Any of the undeblocked or partially deblocked lines can be used to replace the missing lines 1610 in any order. In particular, the padding operation here may be a repetition of already available information. It helps to regularization of the filtering operation at the continuities. Therefore, the padding operation does not result in any new information that could help to improve the estimation of the original pixels.

However, since the deblocked and partly deblocked or undeblocked signals are essentially two different signals as they carry different information. In addition to regularization of the filtering, padding with undeblocked or partially deblocked lines offers improved estimation of the original pixel. In this example, a filter of a cropped diamond form has been used. However, the present invention is not limited to such a form or to the previously illustrated diamond form. The present invention is applicable to any form of the filter, it also does not need to be symmetrical.

An advantage of this embodiment of the present invention is a further increased possibility of line memory reduction In the example shown in FIG. 16, the required line memory is only 4 lines, and this size is fixed. As will be clear for those skilled in the art, the number 4 of lines is only an example and the size of line memory may be configured to support more or less lines (e.g. 1, 2, 3, 5, 6, etc. lines) to be stored for the purpose of deblocking and ALF filtering. The operation of this embodiment may be performed as follows:

1. Partially deblocked or undeblocked pixels are used by the taps of a lower half of the ALF instead of waiting for the deblocked pixels in to reduce the line memory by 3. This approach has been exemplified in FIGS. 6 to 15 as described above.

2. Additionally, the selected partially deblocked or undeblocked lines are copied to positions 1610 in order to further reduce the line memory by 2 more lines as shown in FIG. 16.

However, it should be noted that the present invention is not limited to the above embodiment and that especially point 2 may also be applied without point 1. In particular, deblocked, undeblocked and/or partially deblocked signals from different positions may be used for filtering by some filter taps while the rest of the taps are applied to the deblocked signal. Combinations of all described embodiments are also possible.

For instance, the padding may be performed by replacing the pixels in the two lines 1610 with pixels from lines 3 and 2 respectively. Alternatively, the content of line 1 may be padded to both lines 1610. Still alternatively, the replacement may take into account directional structure of the block and replace the lines 1610 with a correspondingly horizontally shifted lines stored.

However, the present invention is not limited to these examples and, in general, any combination of lines 1 to 4 (referring to FIG. 16) are possible for substituting lines 1610. Actually both partially deblocked (or non-deblocked) and deblocked versions of these 4 lines are available at the decoder. Therefore, in this example, 8 different lines are available to select from. Since the deblocking filtering is designed to increase mainly the subjective quality, sometimes it may reduce the objective quality. The ALF on the other hand increases the objective quality (pixel-wise distortion) of the signal. Therefore, sometimes using non-deblocked signal as an input to ALF may improve the objective quality.

The present invention may be applied to luminance and/or chrominance pixels. It is noted that the present invention is applicable to any of the color spaces and their components.

The input signal used by the adaptive loop filter depends on the pixel position to be filtered, in particular on the relative position with respect to coding unit (for instance, block, LCU) boundary. Thus, the replacing of deblocked pixels with undeblocked or partially deblocked pixels as described above, may be performed in a predefined fixed manner, depending on the position of the filtered pixel. This may be performed implicitly in the same manner at the encoder and the decoder.

Alternatively, particular approach to replacing the input signal (the deblocked signal) may be signalled to the decoder. For instance, it may be indicated whether the input signal is replaced with undeblocked signal or partially-deblocked signal, and/or whether the undeblocked or partially deblocked signal is from the same respective pixel positions (cf. embodiments described with reference to FIGS. 6 to 15) or from different positions (cf. padding, embodiment described with respect to FIG. 16). In particular, the number of lines to be padded may be signalled and/or the position of lines to be used for padding the selected lines.

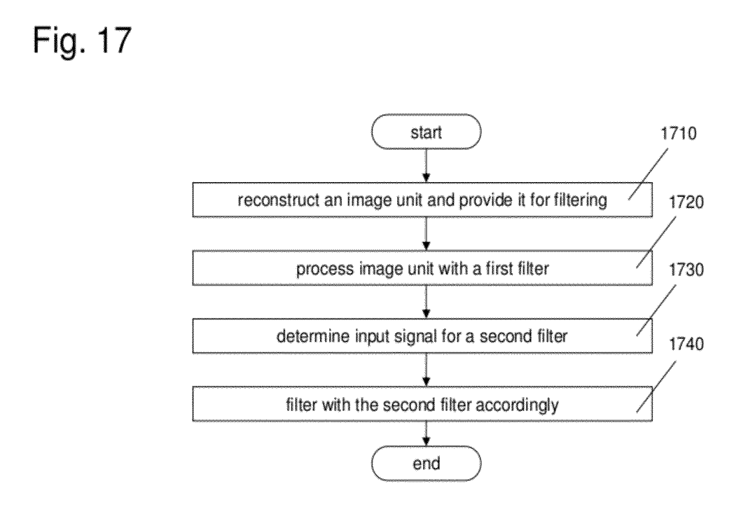

FIG. 17 summarizes a method according to the present invention employed at the encoder or the decoder side in a decoding unit. The signal to be filtered is typically a reconstructed encoded and decoded signal s′ as illustrated in FIGS. 7 and 8. The reconstructed signal is provided 1710 for filtering. First, the provided signal is processed 1720 by the deblocking filter. The processing by the deblocking filter may further include decision whether the deblocking filter is to be applied and to which pixels (pixel positions) within the current block it is to be applied. The pixels for consideration by the deblocking filter are typically predetermined pixels in proximity of the block boundaries. Thus, the predetermined pixels are checked and a decision is performed on whether they are to be filtered and/or used for filtering. To be filtered here means that the filtered value is modified. To be used for filtering means that a tap of a filter for filtering another pixel is applied to a pixel used for filtering. Accordingly, the deblocking filtering may then be applied. The adaptive loop filter filters pixels already processed by the deblocking filter. Still, not all pixels used for adaptive loop filter may be available. Therefore, it is determined, which input signal is to be used for filtering of a deblocked pixel.

In particular, the determination may be performed at the encoder side in accordance with its capabilities and memory available and with aim to reduce line memory requirements at the decoder. The position of the filtered pixel, in particular with respect to boundaries of the coding unit (current block), is also considered. Such determination may also include considering the resulting filterer signal quality and be a part of a rate-distortion optimization. The result of determination may be indicated within the encoded bitstream (including encoded image data of the current block) to the decoder. In particular a flag may be signalled whether ALF is to be applied at all. In case it is to be applied, an indicator may signal the number of lines, the type of the input signal (deblocked, undeblocked, partly deblocked) to be used for filtering, etc. as described above.

At the decoder side, the determination may be performed based on the signalled indicator extracted from the bitstream as described above. The position of the filtered pixel within the current block, and in particular relatively to its boundaries, is to be considered, too. In such a way, the pixels that should undergo deblocking may be replaced for the aim of adaptive filtering with undeblocked pixels or partially deblocked pixels from the corresponding pixel positions. Alternatively, or in addition thereto, they may be replaced with pixels from other positions, in particular, from other lines (rows or columns) of the current block.

Once the input signal to the adaptive loop filter is determined 1730, the adaptive loop filtering 1740 is performed accordingly.

The above description referring to FIG. 17 assumed that the first filter is the deblocking filter and the second filter is the adaptive loop filter. However, the present invention is not limited thereto. The present invention provides similar benefits for the case in which the first filter is the adaptive loop filter and the second filter is the deblocking filter. In such a case, a pixel is filtered by the adaptive loop filter first and then it is filtered by the deblocking filter, wherein some taps of the deblocking filter may be applied to pixels which have not (yet) been processed and/or filtered by the adaptive loop filter, or to pixels that have only been partially filtered by the adaptive loop filter as well as to the pixels which have already been filtered by the deblocking filter.

The first and the second filter are not necessarily adaptive loop filter and deblocking filter. In general, the present invention is applicable to any two filters connected in a cascade, i.e. where the output of the first filter is the input to the second filter, and where processing of the first and/or second filter requires storing lines of pixels in a memory.

The processing described in each of embodiments can be simply implemented in an independent computer system, by recording, in a recording medium, a program for implementing the configurations of the video coding method and the video decoding method described in each of embodiments. The recording media may be any recording media as long as the program can be recorded, such as a magnetic disk, an optical disk, a magnetic optical disk, an IC card, and a semiconductor memory.

Hereinafter, the applications to the video coding method and the video decoding method described in each of embodiments and systems using thereof will be described.

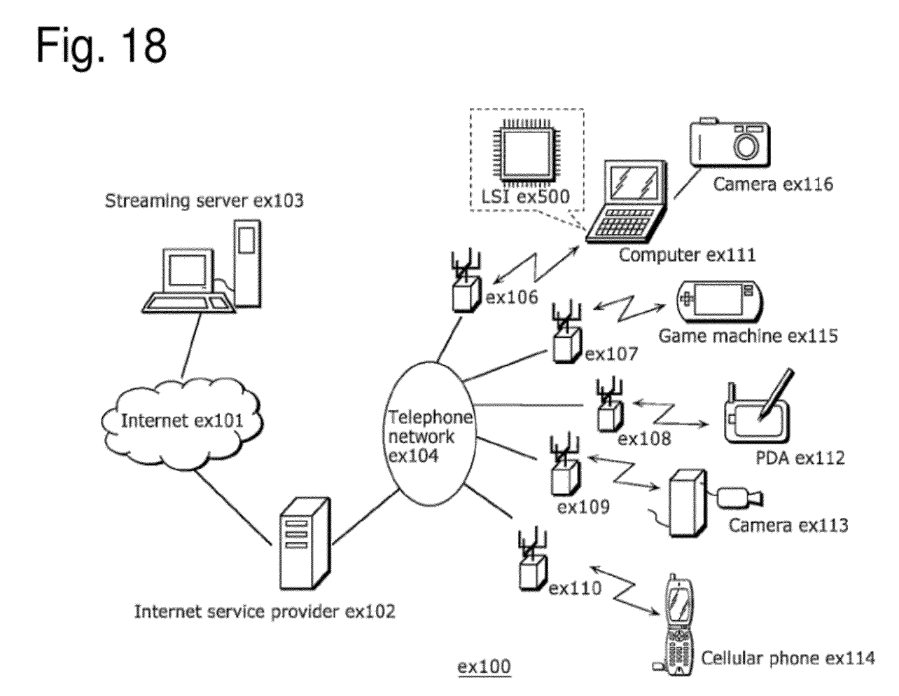

FIG. 18 illustrates an overall configuration of a content providing system ex100 for implementing content distribution services. The area for providing communication services is divided into cells of desired size, and base stations ex106, ex107, ex108, ex109, and ex110 which are fixed wireless stations are placed in each of the cells.

The content providing system ex100 is connected to devices, such as a computer ex111, a personal digital assistant (PDA) ex112, a camera ex113, a cellular phone ex114 and a game machine ex115, via the Internet ex101, an Internet service provider ex102, a telephone network ex104, as well as the base stations ex106 to ex110, respectively.

However, the configuration of the content providing system ex100 is not limited to the configuration shown in FIG. 18, and a combination in which any of the elements are connected is acceptable. In addition, each device may be directly connected to the telephone network ex104, rather than via the base stations ex106 to ex110 which are the fixed wireless stations. Furthermore, the devices may be interconnected to each other via a short distance wireless communication and others.

The camera ex113, such as a digital video camera, is capable of capturing video. A camera ex116, such as a digital video camera, is capable of capturing both still images and video. Furthermore, the cellular phone ex114 may be the one that meets any of the standards such as Global System for Mobile Communications (GSM), Code Division Multiple Access (CDMA), Wideband-Code Division Multiple Access (W-CDMA), Long Term Evolution (LTE), and High Speed Packet Access (HSPA). Alternatively, the cellular phone ex114 may be a Personal Handyphone System (PHS).

In the content providing system ex100, a streaming server ex103 is connected to the camera ex113 and others via the telephone network ex104 and the base station ex109, which enables distribution of images of a live show and others. In such a distribution, a content (for example, video of a music live show) captured by the user using the camera ex113 is coded as described above in each of embodiments, and the coded content is transmitted to the streaming server ex103. On the other hand, the streaming server ex103 carries out stream distribution of the transmitted content data to the clients upon their requests. The clients include the computer ex111, the PDA ex112, the camera ex113, the cellular phone ex114, and the game machine ex115 that are capable of decoding the above-mentioned coded data. Each of the devices that have received the distributed data decodes and reproduces the coded data.

The captured data may be coded by the camera ex113 or the streaming server ex103 that transmits the data, or the coding processes may be shared between the camera ex113 and the streaming server ex103. Similarly, the distributed data may be decoded by the clients or the streaming server ex103, or the decoding processes may be shared between the clients and the streaming server ex103. Furthermore, the data of the still images and video captured by not only the camera ex113 but also the camera ex116 may be transmitted to the streaming server ex103 through the computer ex111. The coding processes may be performed by the camera ex116, the computer ex111, or the streaming server ex103, or shared among them.

Furthermore, the coding and decoding processes may be performed by an LSI ex500 generally included in each of the computer ex111 and the devices. The LSI ex500 may be configured of a single chip or a plurality of chips. Software for coding and decoding video may be integrated into some type of a recording medium (such as a CD-ROM, a flexible disk, and a hard disk) that is readable by the computer ex111 and others, and the coding and decoding processes may be performed using the software. Furthermore, when the cellular phone ex114 is equipped with a camera, the image data obtained by the camera may be transmitted. The video data is data coded by the LSI ex500 included in the cellular phone ex114.

Furthermore, the streaming server ex103 may be composed of servers and computers, and may decentralize data and process the decentralized data, record, or distribute data.

As described above, the clients may receive and reproduce the coded data in the content providing system ex100. In other words, the clients can receive and decode information transmitted by the user, and reproduce the decoded data in real time in the content providing system ex100, so that the user who does not have any particular right and equipment can implement personal broadcasting.

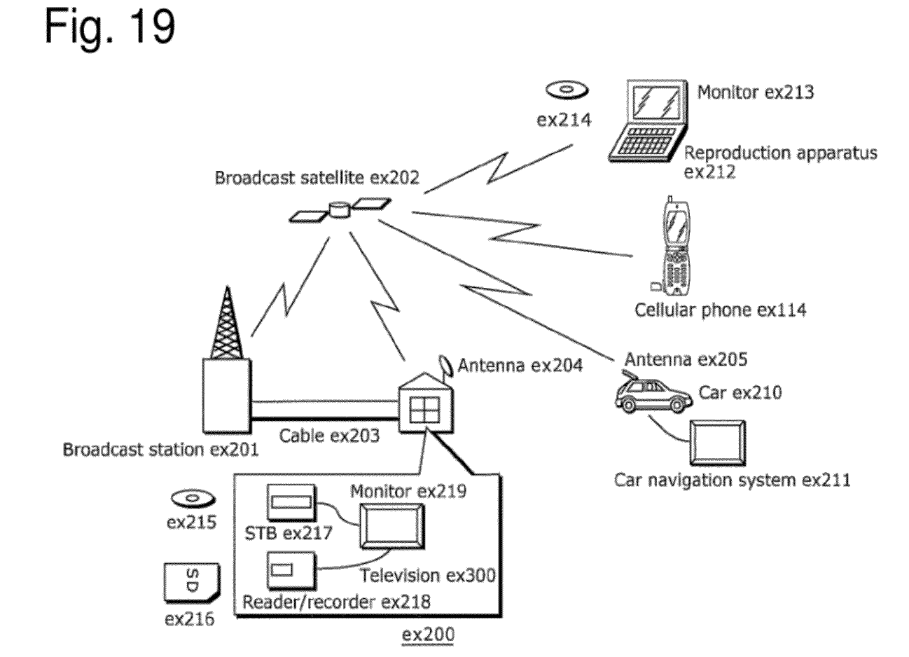

Aside from the example of the content providing system ex100, at least one of the video coding apparatus and the video decoding apparatus described in each of embodiments may be implemented in a digital broadcasting system ex200 illustrated in FIG. 19. More specifically, a broadcast station ex201 communicates or transmits, via radio waves to a broadcast satellite ex202, multiplexed data obtained by multiplexing audio data and others onto video data. The video data is data coded by the video coding method described in each of embodiments. Upon receipt of the multiplexed data, the broadcast satellite ex202 transmits radio waves for broadcasting. Then, a home-use antenna ex204 with a satellite broadcast reception function receives the radio waves.

Next, a device such as a television (receiver) ex300 and a set top box (STB) ex217 decodes the received multiplexed data, and reproduces the decoded data.

Furthermore, a reader/recorder ex218 (i) reads and decodes the multiplexed data recorded on a recording media ex215, such as a DVD and a BD, or (i) codes video signals in the recording medium ex215, and in some cases, writes data obtained by multiplexing an audio signal on the coded data. The reader/recorder ex218 can include the video decoding apparatus or the video coding apparatus as shown in each of embodiments. In this case, the reproduced video signals are displayed on the monitor ex219, and can be reproduced by another device or system using the recording medium ex215 on which the multiplexed data is recorded. It is also possible to implement the video decoding apparatus in the set top box ex217 connected to the cable ex203 for a cable television or to the antenna ex204 for satellite and/or terrestrial broadcasting, so as to display the video signals on the monitor ex219 of the television ex300. The video decoding apparatus may be implemented not in the set top box but in the television ex300.

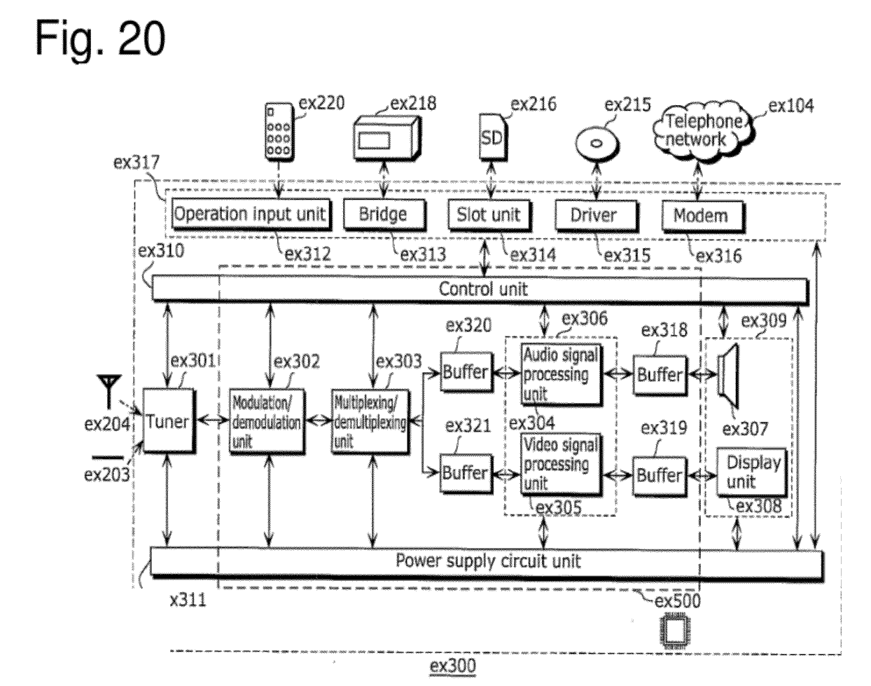

FIG. 20 illustrates the television (receiver) ex300 that uses the video coding method and the video decoding method described in each of embodiments. The television ex300 includes: a tuner ex301 that obtains or provides multiplexed data obtained by multiplexing audio data onto video data, through the antenna ex204 or the cable ex203, etc. that receives a broadcast; a modulation/demodulation unit ex302 that demodulates the received multiplexed data or modulates data into multiplexed data to be supplied outside; and a multiplexing/demultiplexing unit ex303 that demultiplexes the modulated multiplexed data into video data and audio data, or multiplexes video data and audio data coded by a signal processing unit ex306 into data.

The television ex300 further includes: a signal processing unit ex306 including an audio signal processing unit ex304 and a video signal processing unit ex305 that decode audio data and video data and code audio data and video data, respectively; and an output unit ex309 including a speaker ex307 that provides the decoded audio signal, and a display unit ex308 that displays the decoded video signal, such as a display. Furthermore, the television ex300 includes an interface unit ex317 including an operation input unit ex312 that receives an input of a user operation. Furthermore, the television ex300 includes a control unit ex310 that controls overall each constituent element of the television ex300, and a power supply circuit unit ex311 that supplies power to each of the elements. Other than the operation input unit ex312, the interface unit ex317 may include: a bridge ex313 that is connected to an external device, such as the reader/recorder ex218; a slot unit ex314 for enabling attachment of the recording medium ex216, such as an SD card; a driver ex315 to be connected to an external recording medium, such as a hard disk; and a modem ex316 to be connected to a telephone network. Here, the recording medium ex216 can electrically record information using a non-volatile/volatile semiconductor memory element for storage. The constituent elements of the television ex300 are connected to each other through a synchronous bus.

First, the configuration in which the television ex300 decodes multiplexed data obtained from outside through the antenna ex204 and others and reproduces the decoded data will be described. In the television ex300, upon a user operation through a remote controller ex220 and others, the multiplexing/demultiplexing unit ex303 demultiplexes the multiplexed data demodulated by the modulation/demodulation unit ex302, under control of the control unit ex310 including a CPU. Furthermore, the audio signal processing unit ex304 decodes the demultiplexed audio data, and the video signal processing unit ex305 decodes the demultiplexed video data, using the decoding method described in each of embodiments, in the television ex300. The output unit ex309 provides the decoded video signal and audio signal outside, respectively. When the output unit ex309 provides the video signal and the audio signal, the signals may be temporarily stored in buffers ex318 and ex319, and others so that the signals are reproduced in synchronization with each other. Furthermore, the television ex300 may read multiplexed data not through a broadcast and others but from the recording media ex215 and ex216, such as a magnetic disk, an optical disk, and a SD card. Next, a configuration in which the television ex300 codes an audio signal and a video signal, and transmits the data outside or writes the data on a recording medium will be described. In the television ex300, upon a user operation through the remote controller ex220 and others, the audio signal processing unit ex304 codes an audio signal, and the video signal processing unit ex305 codes a video signal, under control of the control unit ex310 using the coding method described in each of embodiments. The multiplexing/demultiplexing unit ex303 multiplexes the coded video signal and audio signal, and provides the resulting signal outside. When the multiplexing/demultiplexing unit ex303 multiplexes the video signal and the audio signal, the signals may be temporarily stored in the buffers ex320 and ex321, and others so that the signals are reproduced in synchronization with each other. Here, the buffers ex318, ex319, ex320, and ex321 may be plural as illustrated, or at least one buffer may be shared in the television ex300. Furthermore, data may be stored in a buffer so that the system overflow and underflow may be avoided between the modulation/demodulation unit ex302 and the multiplexing/demultiplexing unit ex303, for example.

Furthermore, the television ex300 may include a configuration for receiving an AV input from a microphone or a camera other than the configuration for obtaining audio and video data from a broadcast or a recording medium, and may code the obtained data. Although the television ex300 can code, multiplex, and provide outside data in the description, it may be capable of only receiving, decoding, and providing outside data but not the coding, multiplexing, and providing outside data.

Furthermore, when the reader/recorder ex218 reads or writes multiplexed data from or on a recording medium, one of the television ex300 and the reader/recorder ex218 may decode or code the multiplexed data, and the television ex300 and the reader/recorder ex218 may share the decoding or coding.

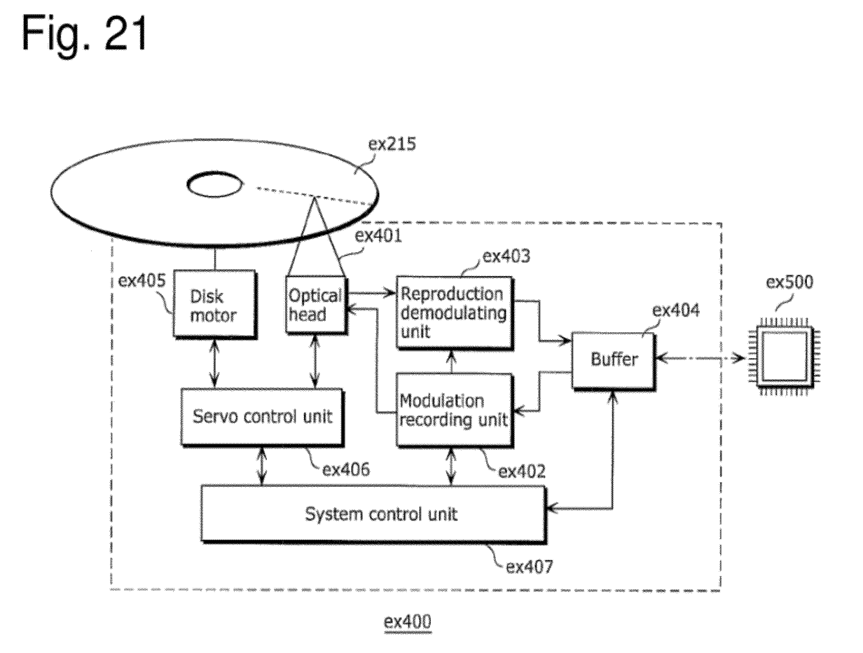

As an example, FIG. 21 illustrates a configuration of an information reproducing/recording unit ex400 when data is read or written from or on an optical disk. The information reproducing/recording unit ex400 includes constituent elements ex401, ex402, ex403, ex404, ex405, ex406, and ex407 to be described hereinafter. The optical head ex401 irradiates a laser spot in a recording surface of the recording medium ex215 that is an optical disk to write information, and detects reflected light from the recording surface of the recording medium ex215 to read the information. The modulation recording unit ex402 electrically drives a semiconductor laser included in the optical head ex401, and modulates the laser light according to recorded data. The reproduction demodulating unit ex403 amplifies a reproduction signal obtained by electrically detecting the reflected light from the recording surface using a photo detector included in the optical head ex401, and demodulates the reproduction signal by separating a signal component recorded on the recording medium ex215 to reproduce the necessary information. The buffer ex404 temporarily holds the information to be recorded on the recording medium ex215 and the information reproduced from the recording medium ex215. The disk motor ex405 rotates the recording medium ex215. The servo control unit ex406 moves the optical head ex401 to a predetermined information track while controlling the rotation drive of the disk motor ex405 so as to follow the laser spot. The system control unit ex407 controls overall the information reproducing/recording unit ex400. The reading and writing processes can be implemented by the system control unit ex407 using various information stored in the buffer ex404 and generating and adding new information as necessary, and by the modulation recording unit ex402, the reproduction demodulating unit ex403, and the servo control unit ex406 that record and reproduce information through the optical head ex401 while being operated in a coordinated manner. The system control unit ex407 includes, for example, a microprocessor, and executes processing by causing a computer to execute a program for read and write.

Although the optical head ex401 irradiates a laser spot in the description, it may perform high-density recording using near field light.

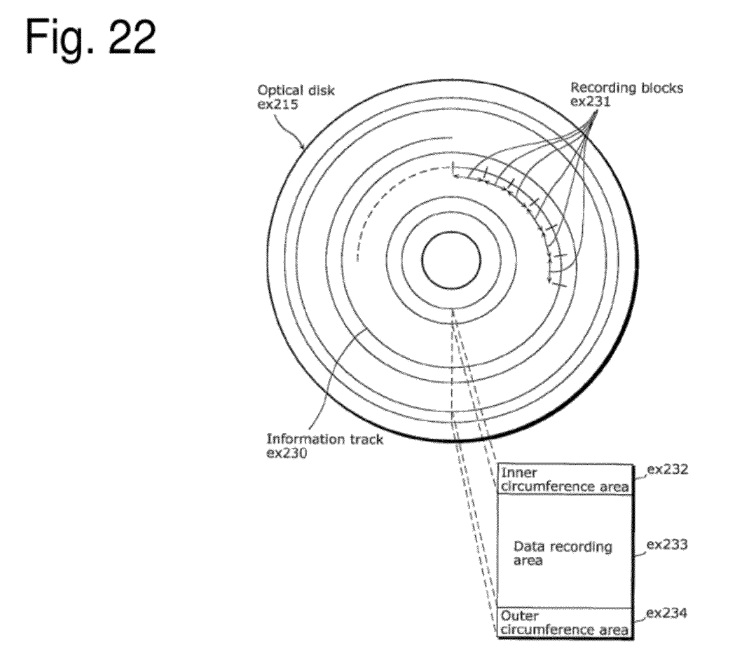

FIG. 22 illustrates the recording medium ex215 that is the optical disk. On the recording surface of the recording medium ex215, guide grooves are spirally formed, and an information track ex230 records, in advance, address information indicating an absolute position on the disk according to change in a shape of the guide grooves. The address information includes information for determining positions of recording blocks ex231 that are a unit for recording data. Reproducing the information track ex230 and reading the address information in an apparatus that records and reproduces data can lead to determination of the positions of the recording blocks. Furthermore, the recording medium ex215 includes a data recording area ex233, an inner circumference area ex232, and an outer circumference area ex234. The data recording area ex233 is an area for use in recording the user data. The inner circumference area ex232 and the outer circumference area ex234 that are inside and outside of the data recording area ex233, respectively are for specific use except for recording the user data. The information reproducing/recording unit 400 reads and writes coded audio, coded video data, or multiplexed data obtained by multiplexing the coded audio and video data, from and on the data recording area ex233 of the recording medium ex215.

Although an optical disk having a layer, such as a DVD and a BD is described as an example in the description, the optical disk is not limited to such, and may be an optical disk having a multilayer structure and capable of being recorded on a part other than the surface. Furthermore, the optical disk may have a structure for multidimensional recording/reproduction, such as recording of information using light of colors with different wavelengths in the same portion of the optical disk and for recording information having different layers from various angles.

Furthermore, a car ex210 having an antenna ex205 can receive data from the satellite ex202 and others, and reproduce video on a display device such as a car navigation system ex211 set in the car ex210, in the digital broadcasting system ex200. Here, a configuration of the car navigation system ex211 will be a configuration, for example, including a GPS receiving unit from the configuration illustrated in FIG. 20. The same will be true for the configuration of the computer ex111, the cellular phone ex114, and others.

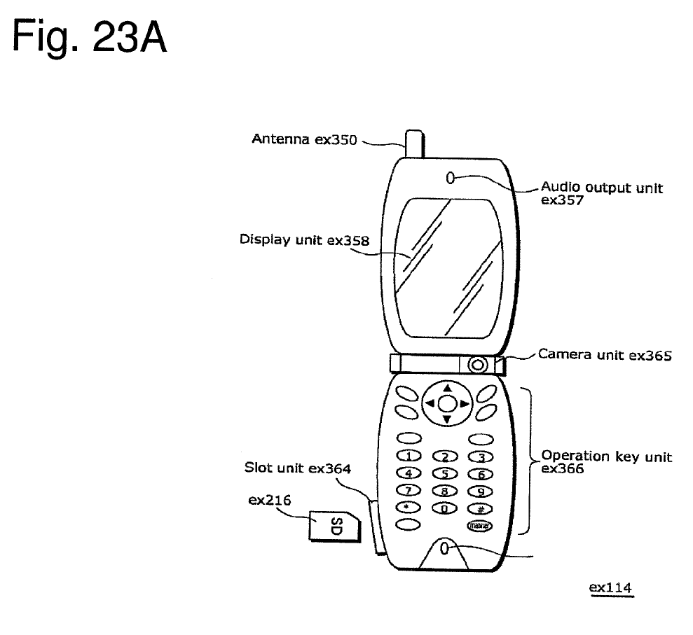

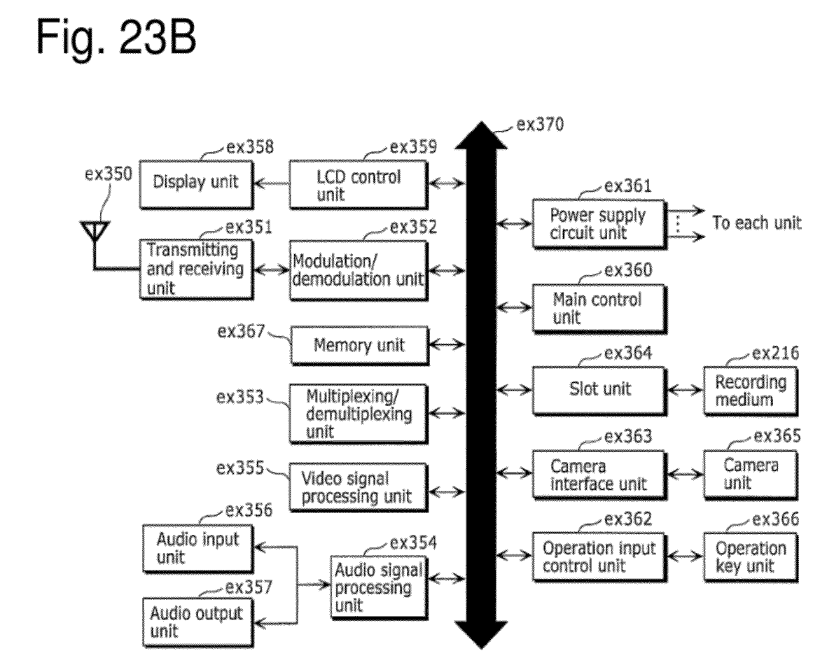

FIG. 23A illustrates the cellular phone ex114 that uses the video coding method and the video decoding method described in embodiments. The cellular phone ex114 includes: an antenna ex350 for transmitting and receiving radio waves through the base station ex110; a camera unit ex365 capable of capturing moving and still images; and a display unit ex358 such as a liquid crystal display for displaying the data such as decoded video captured by the camera unit ex365 or received by the antenna ex350. The cellular phone ex114 further includes: a main body unit including an operation key unit ex366; an audio output unit ex357 such as a speaker for output of audio; an audio input unit ex356 such as a microphone for input of audio; a memory unit ex367 for storing captured video or still pictures, recorded audio, coded or decoded data of the received video, the still pictures, e-mails, or others; and a slot unit ex364 that is an interface unit for a recording medium that stores data in the same manner as the memory unit ex367.

Next, an example of a configuration of the cellular phone ex114 will be described with reference to FIG. 23B. In the cellular phone ex114, a main control unit ex360 designed to control overall each unit of the main body including the display unit ex358 as well as the operation key unit ex366 is connected mutually, via a synchronous bus ex370, to a power supply circuit unit ex361, an operation input control unit ex362, a video signal processing unit ex355, a camera interface unit ex363, a liquid crystal display (LCD) control unit ex359, a modulation/demodulation unit ex352, a multiplexing/demultiplexing unit ex353, an audio signal processing unit ex354, the slot unit ex364, and the memory unit ex367.

When a call-end key or a power key is turned ON by a user's operation, the power supply circuit unit ex361 supplies the respective units with power from a battery pack so as to activate the cell phone ex114.

In the cellular phone ex114, the audio signal processing unit ex354 converts the audio signals collected by the audio input unit ex356 in voice conversation mode into digital audio signals under the control of the main control unit ex360 including a CPU, ROM, and RAM. Then, the modulation/demodulation unit ex352 performs spread spectrum processing on the digital audio signals, and the transmitting and receiving unit ex351 performs digital-to-analog conversion and frequency conversion on the data, so as to transmit the resulting data via the antenna ex350.

Also, in the cellular phone ex114, the transmitting and receiving unit ex351 amplifies the data received by the antenna ex350 in voice conversation mode and performs frequency conversion and the analog-to-digital conversion on the data. Then, the modulation/demodulation unit ex352 performs inverse spread spectrum processing on the data, and the audio signal processing unit ex354 converts it into analog audio signals, so as to output them via the audio output unit ex356.

Furthermore, when an e-mail in data communication mode is transmitted, text data of the e-mail inputted by operating the operation key unit ex366 and others of the main body is sent out to the main control unit ex360 via the operation input control unit ex362. The main control unit ex360 causes the modulation/demodulation unit ex352 to perform spread spectrum processing on the text data, and the transmitting and receiving unit ex351 performs the digital-to-analog conversion and the frequency conversion on the resulting data to transmit the data to the base station ex110 via the antenna ex350. When an e-mail is received, processing that is approximately inverse to the processing for transmitting an e-mail is performed on the received data, and the resulting data is provided to the display unit ex358.

When video, still images, or video and audio in data communication mode is or are transmitted, the video signal processing unit ex355 compresses and codes video signals supplied from the camera unit ex365 using the video coding method shown in each of embodiments, and transmits the coded video data to the multiplexing/demultiplexing unit ex353. In contrast, during when the camera unit ex365 captures video, still images, and others, the audio signal processing unit ex354 codes audio signals collected by the audio input unit ex356, and transmits the coded audio data to the multiplexing/demultiplexing unit ex353.

The multiplexing/demultiplexing unit ex353 multiplexes the coded video data supplied from the video signal processing unit ex355 and the coded audio data supplied from the audio signal processing unit ex354, using a predetermined method.

Then, the modulation/demodulation unit ex352 performs spread spectrum processing on the multiplexed data, and the transmitting and receiving unit ex351 performs digital-to-analog conversion and frequency conversion on the data so as to transmit the resulting data via the antenna ex350.

When receiving data of a video file which is linked to a Web page and others in data communication mode or when receiving an e-mail with video and/or audio attached, in order to decode the multiplexed data received via the antenna ex350, the multiplexing/demultiplexing unit ex353 demultiplexes the multiplexed data into a video data bit stream and an audio data bit stream, and supplies the video signal processing unit ex355 with the coded video data and the audio signal processing unit ex354 with the coded audio data, through the synchronous bus ex370. The video signal processing unit ex355 decodes the video signal using a video decoding method corresponding to the coding method shown in each of embodiments, and then the display unit ex358 displays, for instance, the video and still images included in the video file linked to the Web page via the LCD control unit ex359. Furthermore, the audio signal processing unit ex354 decodes the audio signal, and the audio output unit ex357 provides the audio.

Furthermore, similarly to the television ex300, a terminal such as the cellular phone ex114 probably have 3 types of implementation configurations including not only (i) a transmitting and receiving terminal including both a coding apparatus and a decoding apparatus, but also (ii) a transmitting terminal including only a coding apparatus and (iii) a receiving terminal including only a decoding apparatus. Although the digital broadcasting system ex200 receives and transmits the multiplexed data obtained by multiplexing audio data onto video data in the description, the multiplexed data may be data obtained by multiplexing not audio data but character data related to video onto video data, and may be not multiplexed data but video data itself.

As such, the video coding method and the video decoding method in each of embodiments can be used in any of the devices and systems described. Thus, the advantages described in each of embodiments can be obtained.

Furthermore, the present invention is not limited to embodiments, and various modifications and revisions are possible without departing from the scope of the present invention.

Video data can be generated by switching, as necessary, between (i) the video coding method or the video coding apparatus shown in each of embodiments and (ii) a video coding method or a video coding apparatus in conformity with a different standard, such as MPEG-2, H.264/AVC, and VC-1.

Here, when a plurality of video data that conforms to the different standards is generated and is then decoded, the decoding methods need to be selected to conform to the different standards.

However, since to which standard each of the plurality of the video data to be decoded conform cannot be detected, there is a problem that an appropriate decoding method cannot be selected.

In order to solve the problem, multiplexed data obtained by multiplexing audio data and others onto video data has a structure including identification information indicating to which standard the video data conforms. The specific structure of the multiplexed data including the video data generated in the video coding method and by the video coding apparatus shown in each of embodiments will be hereinafter described. The multiplexed data is a digital stream in the MPEG2-Transport Stream format.

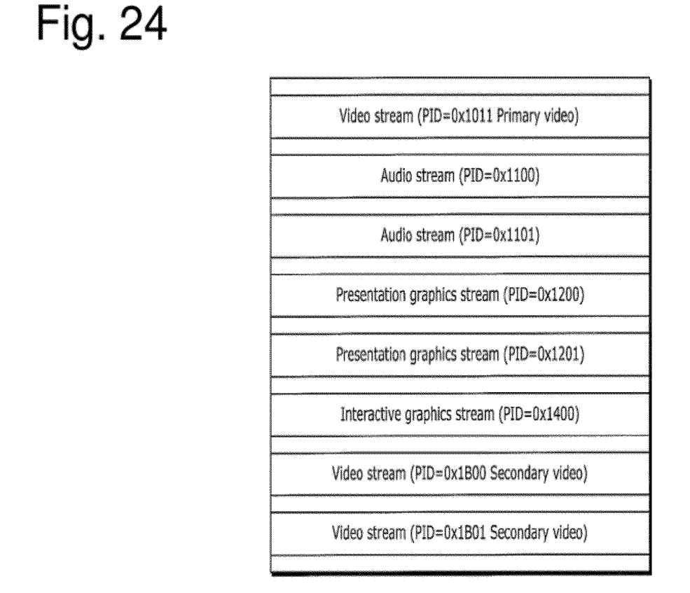

FIG. 24 illustrates a structure of the multiplexed data. As illustrated in FIG. 24, the multiplexed data can be obtained by multiplexing at least one of a video stream, an audio stream, a presentation graphics stream (PG), and an interactive graphics stream. The video stream represents primary video and secondary video of a movie, the audio stream (IG) represents a primary audio part and a secondary audio part to be mixed with the primary audio part, and the presentation graphics stream represents subtitles of the movie. Here, the primary video is normal video to be displayed on a screen, and the secondary video is video to be displayed on a smaller window in the primary video. Furthermore, the interactive graphics stream represents an interactive screen to be generated by arranging the GUI components on a screen. The video stream is coded in the video coding method or by the video coding apparatus shown in each of embodiments, or in a video coding method or by a video coding apparatus in conformity with a conventional standard, such as MPEG-2, H.264/AVC, and VC-1. The audio stream is coded in accordance with a standard, such as Dolby-AC-3, Dolby Digital Plus, MLP, DTS, DTS-HD, and linear PCM.

Each stream included in the multiplexed data is identified by PID. For example, 0x1011 is allocated to the video stream to be used for video of a movie, 0x100 to 0x111F are allocated to the audio streams, 0x1200 to 0x121F are allocated to the presentation graphics streams, 0x1400 to 0x141F are allocated to the interactive graphics streams, 0x1B00 to 0x1B1F are allocated to the video streams to be used for secondary video of the movie, and 0x1A00 to 0x1A1F are allocated to the audio streams to be used for the secondary video to be mixed with the primary audio.

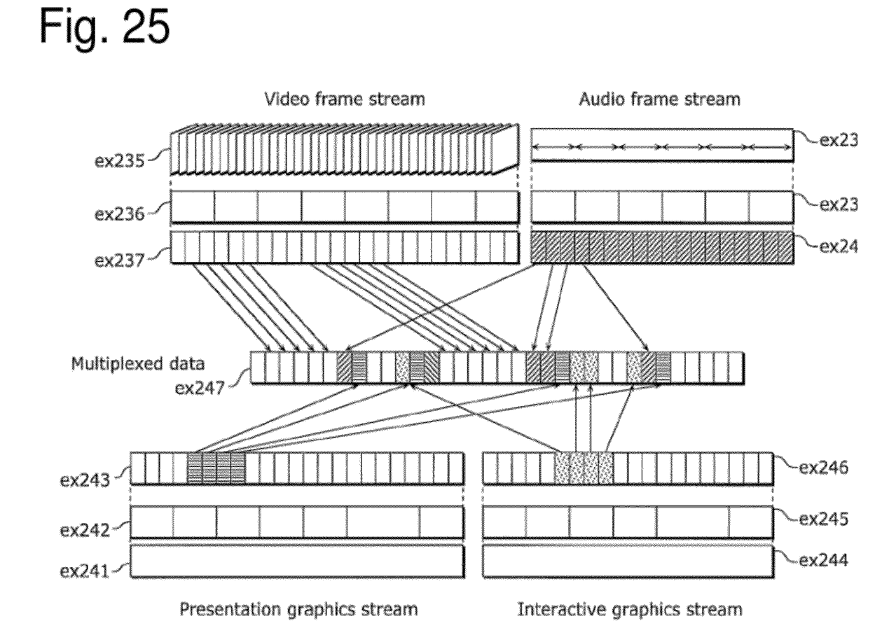

FIG. 25 schematically illustrates how data is multiplexed. First, a video stream ex235 composed of video frames and an audio stream ex238 composed of audio frames are transformed into a stream of PES packets ex236 and a stream of PES packets ex239, and further into TS packets ex237 and TS packets ex240, respectively. Similarly, data of a presentation graphics stream ex241 and data of an interactive graphics stream ex244 are transformed into a stream of PES packets ex242 and a stream of PES packets ex245, and further into TS packets ex243 and TS packets ex246, respectively. These TS packets are multiplexed into a stream to obtain multiplexed data ex247.

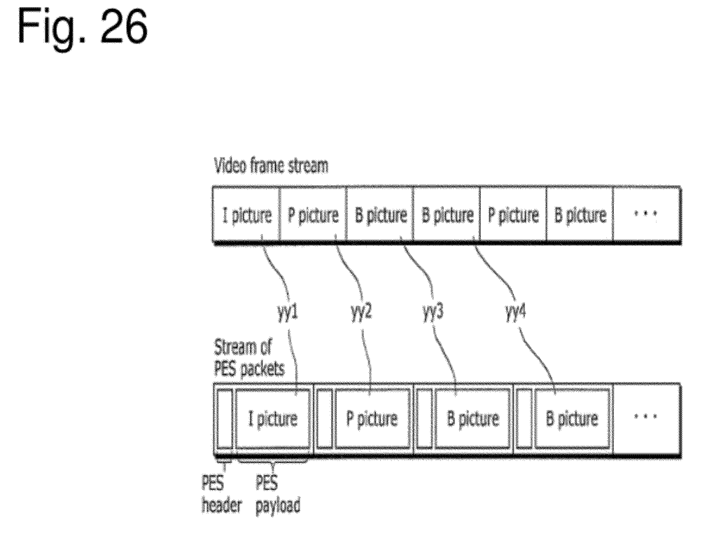

FIG. 26 illustrates how a video stream is stored in a stream of PES packets in more detail. The first bar in FIG. 26 shows a video frame stream in a video stream. The second bar shows the stream of PES packets. As indicated by arrows denoted as yy1, yy2, yy3, and yy4 in FIG. 26, the video stream is divided into pictures as I pictures, B pictures, and P pictures each of which is a video presentation unit, and the pictures are stored in a payload of each of the PES packets. Each of the PES packets has a PES header, and the PES header stores a Presentation Time-Stamp (PTS) indicating a display time of the picture, and a Decoding Time-Stamp (DTS) indicating a decoding time of the picture.

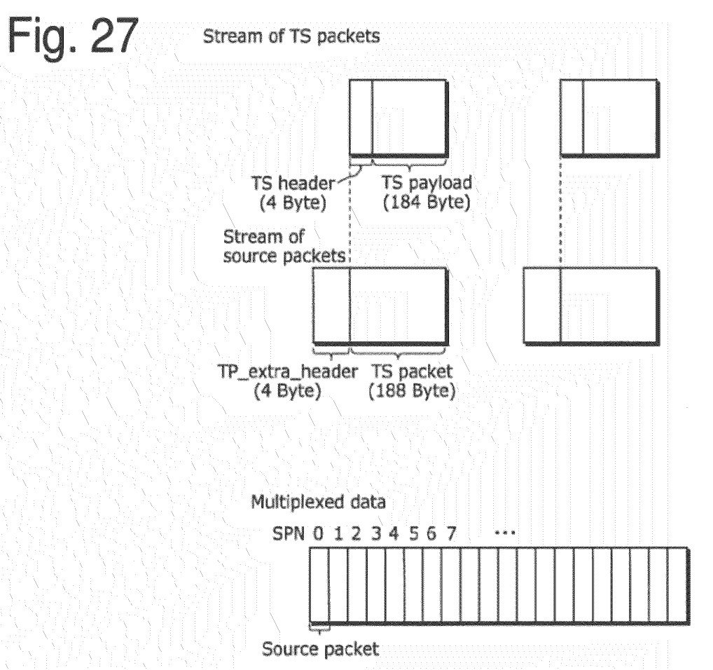

FIG. 27 illustrates a format of TS packets to be finally written on the multiplexed data. Each of the TS packets is a 188-byte fixed length packet including a 4-byte TS header having information, such as a PID for identifying a stream and a 184-byte TS payload for storing data. The PES packets are divided, and stored in the TS payloads, respectively. When a BD ROM is used, each of the TS packets is given a 4-byte TP_Extra_Header, thus resulting in 192-byte source packets. The source packets are written on the multiplexed data. The TP_Extra_Header stores information such as an Arrival_Time_Stamp (ATS). The ATS shows a transfer start time at which each of the TS packets is to be transferred to a PID filter. The source packets are arranged in the multiplexed data as shown at the bottom of FIG. 27. The numbers incrementing from the head of the multiplexed data are called source packet numbers (SPNs).

Each of the TS packets included in the multiplexed data includes not only streams of audio, video, subtitles and others, but also a Program Association Table (PAT), a Program Map Table. (PMT), and a Program Clock Reference (PCR). The PAT shows what a PID in a PMT used in the multiplexed data indicates, and a PID of the PAT itself is registered as zero. The PMT stores PIDs of the streams of video, audio, subtitles and others included in the multiplexed data, and attribute information of the streams corresponding to the PIDs. The PMT also has various descriptors relating to the multiplexed data. The descriptors have information such as copy control information showing whether copying of the multiplexed data is permitted or not. The PCR stores STC time information corresponding to an ATS showing when the PCR packet is transferred to a decoder, in order to achieve synchronization between an Arrival Time Clock (ATC) that is a time axis of ATSs, and an System Time Clock (STC) that is a time axis of PTSs and DTSs.

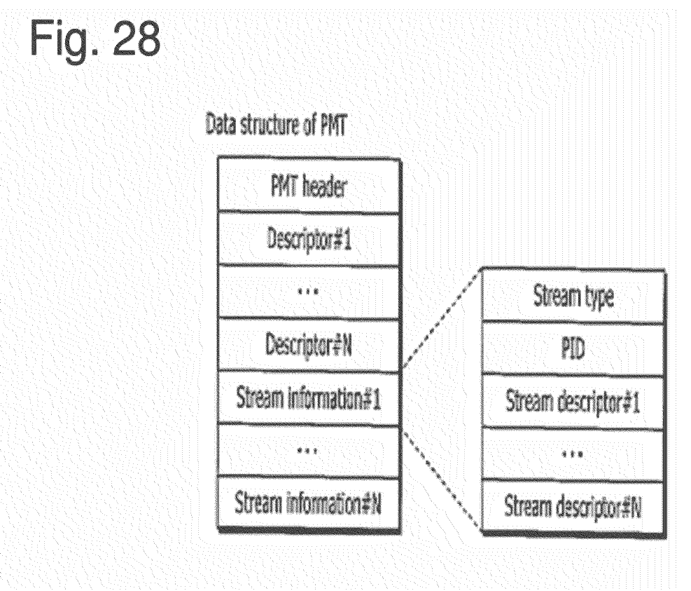

FIG. 28 illustrates the data structure of the PMT in detail. A PMT header is disposed at the top of the PMT. The PMT header describes the length of data included in the PMT and others. A plurality of descriptors relating to the multiplexed data is disposed after the PMT header. Information such as the copy control information is described in the descriptors. After the descriptors, a plurality of pieces of stream information relating to the streams included in the multiplexed data is disposed. Each piece of stream information includes stream descriptors each describing information, such as a stream type for identifying a compression codec of a stream, a stream PID, and stream attribute information (such as a frame rate or an aspect ratio). The stream descriptors are equal in number to the number of streams in the multiplexed data.

When the multiplexed data is recorded on a recording medium and others, it is recorded together with multiplexed data information files.

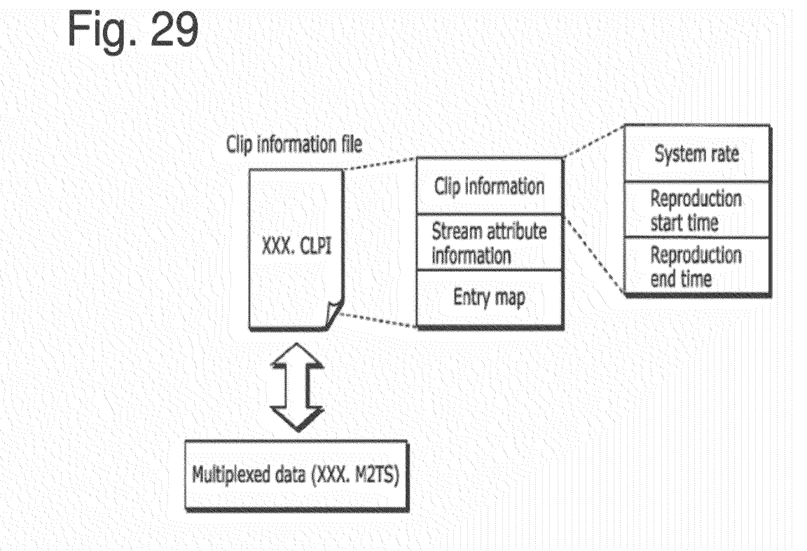

Each of the multiplexed data information files is management information of the multiplexed data as shown in FIG. 29. The multiplexed data information files are in one to one correspondence with the multiplexed data, and each of the files includes multiplexed data information, stream attribute information, and an entry map.

As illustrated in FIG. 29, the multiplexed data includes a system rate, a reproduction start time, and a reproduction end time. The system rate indicates the maximum transfer rate at which a system target decoder to be described later transfers the multiplexed data to a PID filter. The intervals of the ATSs included in the multiplexed data are set to not higher than a system rate. The reproduction start time indicates a PTS in a video frame at the head of the multiplexed data. An interval of one frame is added to a PTS in a video frame at the end of the multiplexed data, and the PTS is set to the reproduction end time.

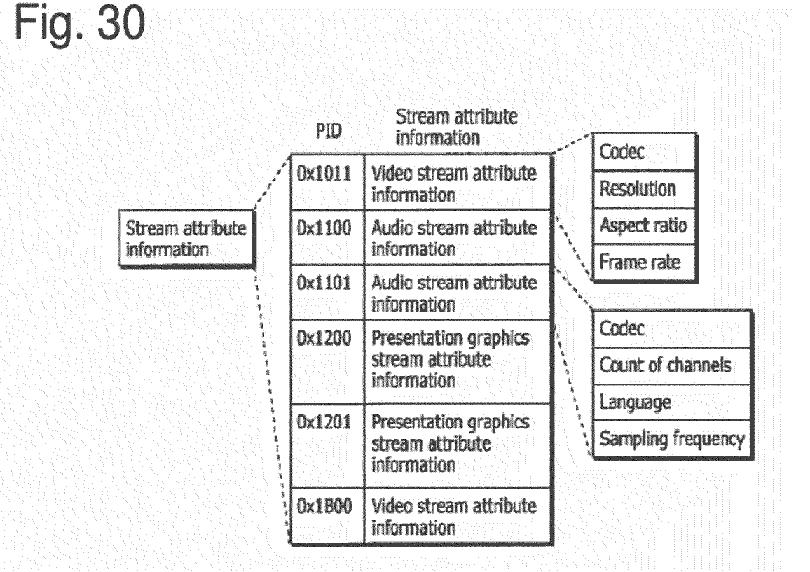

As shown in FIG. 30, a piece of attribute information is registered in the stream attribute information, for each PID of each stream included in the multiplexed data. Each piece of attribute information has different information depending on whether the corresponding stream is a video stream, an audio stream, a presentation graphics stream, or an interactive graphics stream. Each piece of video stream attribute information carries information including what kind of compression codec is used for compressing the video stream, and the resolution, aspect ratio and frame rate of the pieces of picture data that is included in the video stream. Each piece of audio stream attribute information carries information including what kind of compression codec is used for compressing the audio stream, how many channels are included in the audio stream, which language the audio stream supports, and how high the sampling frequency is. The video stream attribute information and the audio stream attribute information are used for initialization of a decoder before the player plays back the information.

The multiplexed data to be used is of a stream type included in the PMT. Furthermore, when the multiplexed data is recorded on a recording medium, the video stream attribute information included in the multiplexed data information is used. More specifically, the video coding method or the video coding apparatus described in each of embodiments includes a step or a unit for allocating unique information indicating video data generated by the video coding method or the video coding apparatus in each of embodiments, to the stream type included in the PMT or the video stream attribute information. With the configuration, the video data generated by the video coding method or the video coding apparatus described in each of embodiments can be distinguished from video data that conforms to another standard.

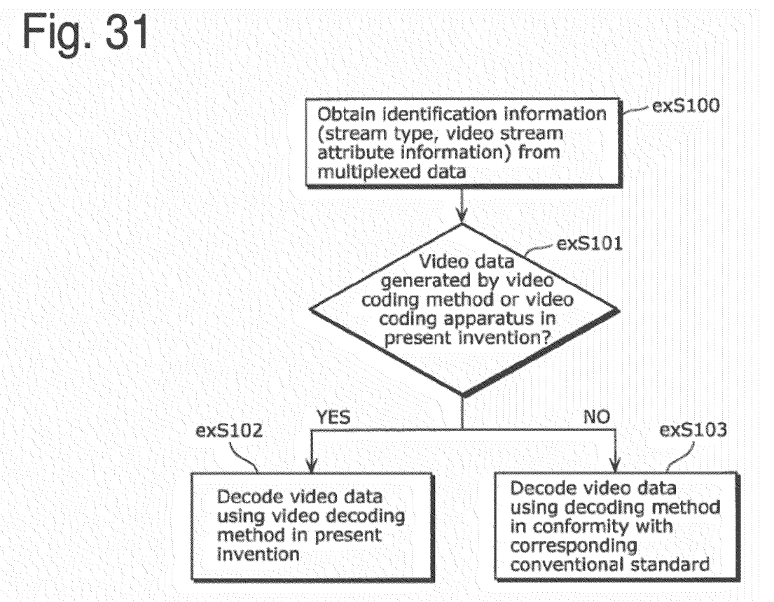

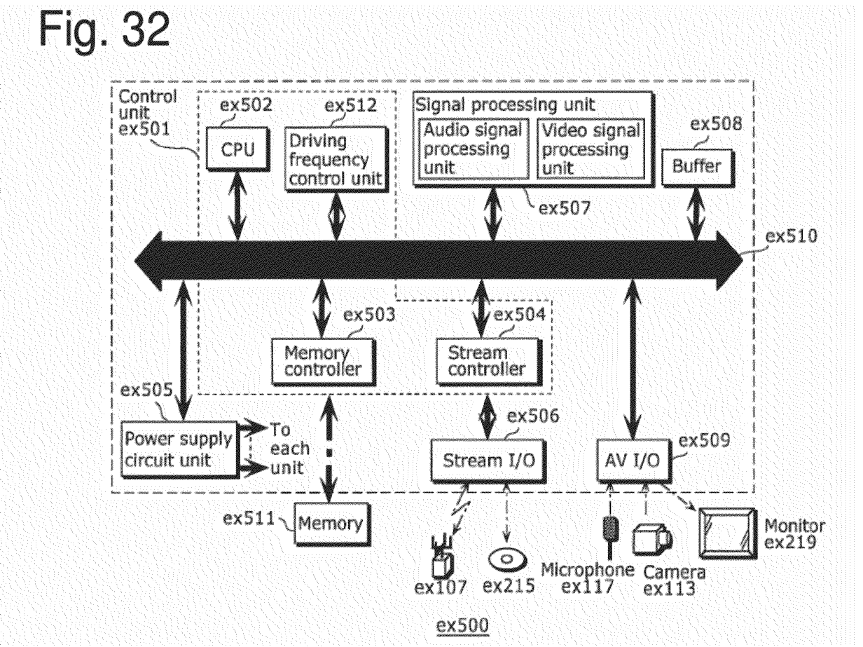

Furthermore, FIG. 31 illustrates steps of the video decoding method. In Step exS100, the stream type included in the PMT or the video stream attribute information is obtained from the multiplexed data. Next, in Step exS101, it is determined whether or not the stream type or the video stream attribute information indicates that the multiplexed data is generated by the video coding method or the video coding apparatus in each of embodiments. When it is determined that the stream type or the video stream attribute information indicates that the multiplexed data is generated by the video coding method or the video coding apparatus in each of embodiments, in Step exS102, decoding is performed by the video decoding method in each of embodiments. Furthermore, when the stream type or the video stream attribute information indicates conformance to the conventional standards, such as MPEG-2, H.264/AVC, and VC-1, in Step exS103, decoding is performed by a video decoding method in conformity with the conventional standards.

As such, allocating a new unique value to the stream type or the video stream attribute information enables determination whether or not the video decoding method or the video decoding apparatus that is described in each of embodiments can perform decoding. Even when multiplexed data that conforms to a different standard, an appropriate decoding method or apparatus can be selected. Thus, it becomes possible to decode information without any error. Furthermore, the video coding method or apparatus, or the video decoding method or apparatus can be used in the devices and systems described above.

Each of the video coding method, the video coding apparatus, the video decoding method, and the video decoding apparatus in each of embodiments is typically achieved in the form of an integrated circuit or a Large Scale Integrated (LSI) circuit. As an example of the LSI, FIG. 32 illustrates a configuration of the LSI ex500 that is made into one chip. The LSI ex500 includes elements ex501, ex502, ex503, ex504, ex505, ex506, ex507, ex508, and ex509 to be described below, and the elements are connected to each other through a bus ex510. The power supply circuit unit ex505 is activated by supplying each of the elements with power when the power supply circuit unit ex505 is turned on.

For example, when coding is performed, the LSI ex500 receives an AV signal from a microphone ex117, a camera ex113, and others through an AV IO ex509 under control of a control unit ex501 including a CPU ex502, a memory controller ex503, a stream controller ex504, and a driving frequency control unit ex512. The received AV signal is temporarily stored in an external memory ex511, such as an SDRAM. Under control of the control unit ex501, the stored data is segmented into data portions according to the processing amount and speed to be transmitted to a signal processing unit ex507. Then, the signal processing unit ex507 codes an audio signal and/or a video signal. Here, the coding of the video signal is the coding described in each of embodiments. Furthermore, the signal processing unit ex507 sometimes multiplexes the coded audio data and the coded video data, and a stream IO ex506 provides the multiplexed data outside. The provided multiplexed data is transmitted to the base station ex107, or written on the recording media ex215. When data sets are multiplexed, the data should be temporarily stored in the buffer ex508 so that the data sets are synchronized with each other.

Although the memory ex511 is an element outside the LSI ex500, it may be included in the LSI ex500. The buffer ex508 is not limited to one buffer, but may be composed of buffers. Furthermore, the LSI ex500 may be made into one chip or a plurality of chips.

Furthermore, although the control unit ex510 includes the CPU ex502, the memory controller ex503, the stream controller ex504, the driving frequency control unit ex512, the configuration of the control unit ex510 is not limited to such. For example, the signal processing unit ex507 may further include a CPU. Inclusion of another CPU in the signal processing unit ex507 can improve the processing speed. Furthermore, as another example, the CPU ex502 may serve as or be a part of the signal processing unit ex507, and, for example, may include an audio signal processing unit. In such a case, the control unit ex501 includes the signal processing unit ex507 or the CPU ex502 including a part of the signal processing unit ex507.

The name used here is LSI, but it may also be called IC, system LSI, super LSI, or ultra LSI depending on the degree of integration.

Moreover, ways to achieve integration are not limited to the LSI, and a special circuit or a general purpose processor and so forth can also achieve the integration. Field Programmable Gate Array (FPGA) that can be programmed after manufacturing LSIs or a reconfigurable processor that allows re-configuration of the connection or configuration of an LSI can be used for the same purpose.

In the future, with advancement in semiconductor technology, a brand-new technology may replace LSI. The functional blocks can be integrated using such a technology. The possibility is that the present invention is applied to biotechnology.

When video data generated in the video coding method or by the video coding apparatus described in each of embodiments is decoded, compared to when video data that conforms to a conventional standard, such as MPEG-2, H.264/AVC, and VC-1 is decoded, the processing amount probably increases. Thus, the LSI ex500 needs to be set to a driving frequency higher than that of the CPU ex502 to be used when video data in conformity with the conventional standard is decoded. However, when the driving frequency is set higher, there is a problem that the power consumption increases.

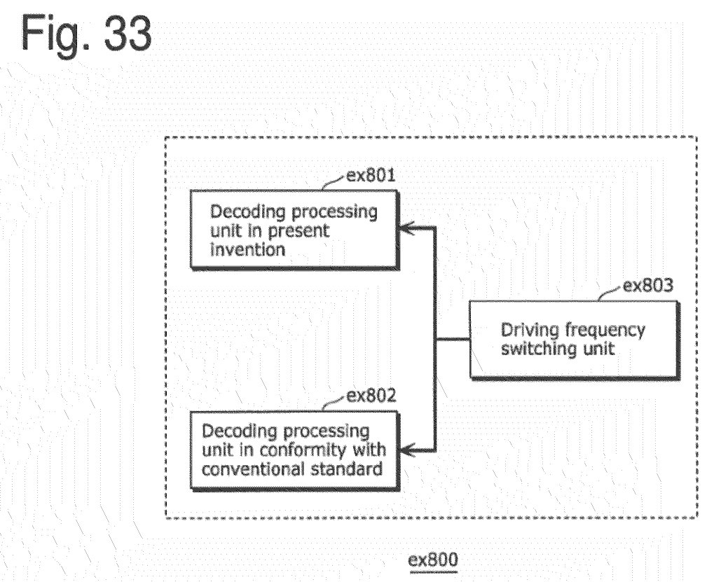

In order to solve the problem, the video decoding apparatus, such as the television ex300 and the LSI ex500 is configured to determine to which standard the video data conforms, and switch between the driving frequencies according to the determined standard. FIG. 33 illustrates a configuration ex800. A driving frequency switching unit ex803 sets a driving frequency to a higher driving frequency when video data is generated by the video coding method or the video coding apparatus described in each of embodiments. Then, the driving frequency switching unit ex803 instructs a decoding processing unit ex801 that executes the video decoding method described in each of embodiments to decode the video data. When the video data conforms to the conventional standard, the driving frequency switching unit ex803 sets a driving frequency to a lower driving frequency than that of the video data generated by the video coding method or the video coding apparatus described in each of embodiments. Then, the driving frequency switching unit ex803 instructs the decoding processing unit ex802 that conforms to the conventional standard to decode the video data.

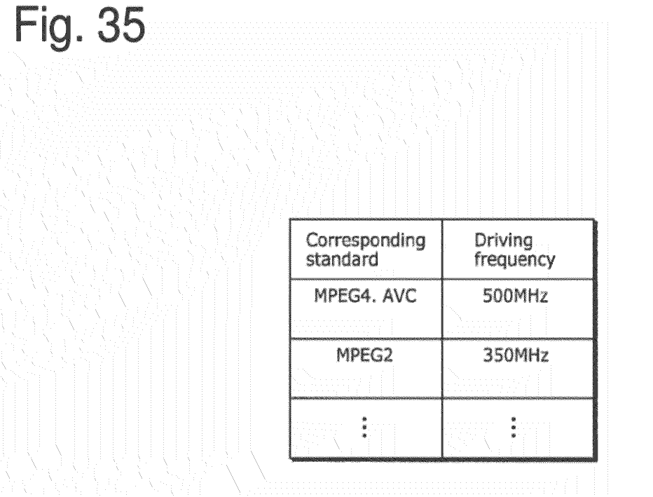

More specifically, the driving frequency switching unit ex803 includes the CPU ex502 and the driving frequency control unit ex512 in FIG. 32. Here, each of the decoding processing unit ex801 that executes the video decoding method described in each of embodiments and the decoding processing unit ex802 that conforms to the conventional standard corresponds to the signal processing unit ex507 in FIG. 30. The CPU ex502 determines to which standard the video data conforms. Then, the driving frequency control unit ex512 determines a driving frequency based on a signal from the CPU ex502. Furthermore, the signal processing unit ex507 decodes the video data based on the signal from the CPU ex502. For example, the identification information described is probably used for identifying the video data. The identification information is not limited to the one described above but may be any information as long as the information indicates to which standard the video data conforms. For example, when which standard video data conforms to can be determined based on an external signal for determining that the video data is used for a television or a disk, etc., the determination may be made based on such an external signal. Furthermore, the CPU ex502 selects a driving frequency based on, for example, a look-up table in which the standards of the video data are associated with the driving frequencies as shown in FIG. 35. The driving frequency can be selected by storing the look-up table in the buffer ex508 and in an internal memory of an LSI, and with reference to the look-up table by the CPU ex502.

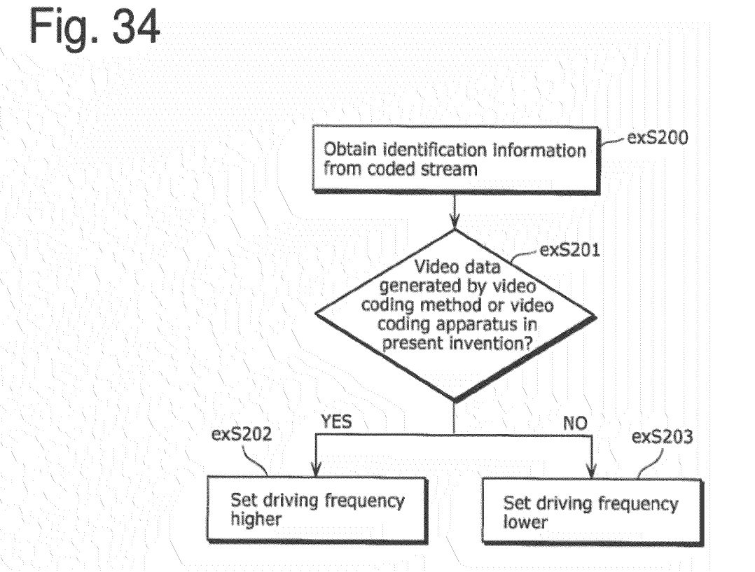

FIG. 34 illustrates steps for executing a method. First, in Step exS200, the signal processing unit ex507 obtains identification information from the multiplexed data. Next, in Step exS201, the CPU ex502 determines whether or not the video data is generated by the coding method and the coding apparatus described in each of embodiments, based on the identification information. When the video data is generated by the video coding method and the video coding apparatus described in each of embodiments, in Step exS202, the CPU ex502 transmits a signal for setting the driving frequency to a higher driving frequency to the driving frequency control unit ex512. Then, the driving frequency control unit ex512 sets the driving frequency to the higher driving frequency. On the other hand, when the identification information indicates that the video data conforms to the conventional standard, such as MPEG-2, H.264/AVC, and VC-1, in Step exS203, the CPU ex502 transmits a signal for setting the driving frequency to a lower driving frequency to the driving frequency control unit ex512. Then, the driving frequency control unit ex512 sets the driving frequency to the lower driving frequency than that in the case where the video data is generated by the video coding method and the video coding apparatus described in each of embodiment.

Furthermore, along with the switching of the driving frequencies, the power conservation effect can be improved by changing the voltage to be applied to the LSI ex500 or an apparatus including the LSI ex500. For example, when the driving frequency is set lower, the voltage to be applied to the LSI ex500 or the apparatus including the LSI ex500 is probably set to a voltage lower than that in the case where the driving frequency is set higher.

Furthermore, when the processing amount for decoding is larger, the driving frequency may be set higher, and when the processing amount for decoding is smaller, the driving frequency may be set lower as the method for setting the driving frequency. Thus, the setting method is not limited to the ones described above. For example, when the processing amount for decoding video data in conformity with H.264/AVC is larger than the processing amount for decoding video data generated by the video coding method and the video coding apparatus described in each of embodiments, the driving frequency is probably set in reverse order to the setting described above.

Furthermore, the method for setting the driving frequency is not limited to the method for setting the driving frequency lower. For example, when the identification information indicates that the video data is generated by the video coding method and the video coding apparatus described in each of embodiments, the voltage to be applied to the LSI ex500 or the apparatus including the LSI ex500 is probably set higher. When the identification information indicates that the video data conforms to the conventional standard, such as MPEG-2, H.264/AVC, and VC-1, the voltage to be applied to the LSI ex500 or the apparatus including the LSI ex500 is probably set lower. As another example, when the identification information indicates that the video data is generated by the video coding method and the video coding apparatus described in each of embodiments, the driving of the CPU ex502 does not probably have to be suspended. When the identification information indicates that the video data conforms to the conventional standard, such as MPEG-2, H.264/AVC, and VC-1, the driving of the CPU ex502 is probably suspended at a given time because the CPU ex502 has extra processing capacity. Even when the identification information indicates that the video data is generated by the video coding method and the video coding apparatus described in each of embodiments, in the case where the CPU ex502 has extra processing capacity, the driving of the CPU ex502 is probably suspended at a given time. In such a case, the suspending time is probably set shorter than that in the case where when the identification information indicates that the video data conforms to the conventional standard, such as MPEG-2, H.264/AVC, and VC-1.

Accordingly, the power conservation effect can be improved by switching between the driving frequencies in accordance with the standard to which the video data conforms. Furthermore, when the LSI ex500 or the apparatus including the LSI ex500 is driven using a battery, the battery life can be extended with the power conservation effect.

There are cases where a plurality of video data that conforms to different standards, is provided to the devices and systems, such as a television and a mobile phone. In order to enable decoding the plurality of video data that conforms to the different standards, the signal processing unit ex507 of the LSI ex500 needs to conform to the different standards. However, the problems of increase in the scale of the circuit of the LSI ex500 and increase in the cost arise with the individual use of the signal processing units ex507 that conform to the respective standards.

In order to solve the problem, what is conceived is a configuration in which the decoding processing unit for implementing the video decoding method described in each of embodiments and the decoding processing unit that conforms to the conventional standard, such as MPEG-2, H.264/AVC, and VC-1 are partly shared. Ex900 in FIG. 36A shows an example of the configuration. For example, the video decoding method described in each of embodiments and the video decoding method that conforms to H.264/AVC have, partly in common, the details of processing, such as entropy coding, inverse quantization, deblocking filtering, and motion compensated prediction. The details of processing to be shared may include use of a decoding processing unit ex902 that conforms to H.264/AVC. In contrast, a dedicated decoding processing unit ex901 is probably used for other processing unique to the present invention. Since the present invention is characterized by application of filtering such as deblocking and adaptive loop filtering, for example, the dedicated decoding processing unit ex901 is used for such filtering. Otherwise, the decoding processing unit is probably shared for one of the entropy decoding, inverse quantization, spatial or motion compensated prediction, or all of the processing. The decoding processing unit for implementing the video decoding method described in each of embodiments may be shared for the processing to be shared, and a dedicated decoding processing unit may be used for processing unique to that of H.264/AVC.

Furthermore, ex1000 in FIG. 36B shows another example in that processing is partly shared. This example uses a configuration including a dedicated decoding processing unit ex1001 that supports the processing unique to the present invention, a dedicated decoding processing unit ex1002 that supports the processing unique to another conventional standard, and a decoding processing unit ex1003 that supports processing to be shared between the video decoding method in the present invention and the conventional video decoding method. Here, the dedicated decoding processing units ex1001 and ex1002 are not necessarily specialized for the processing of the present invention and the processing of the conventional standard, respectively, and may be the ones capable of implementing general processing. Furthermore, the configuration can be implemented by the LSI ex500.

As such, reducing the scale of the circuit of an LSI and reducing the cost are possible by sharing the decoding processing unit for the processing to be shared between the video decoding method in the present invention and the video decoding method in conformity with the conventional standard.

Most of the examples have been outlined in relation to an H.264/AVC based video coding system, and the terminology mainly relates to the H.264/AVC terminology. However, this terminology and the description of the various embodiments with respect to H.264/AVC based coding is not intended to limit the principles and ideas of the invention to such systems. Also the detailed explanations of the encoding and decoding in compliance with the H.264/AVC standard are intended to better understand the exemplary embodiments described herein and should not be understood as limiting the invention to the described specific implementations of processes and functions in the video coding. Nevertheless, the improvements proposed herein may be readily applied in the video coding described. Furthermore the concept of the invention may be also readily used in the enhancements of H.264/AVC coding and/or HEVC currently discussed by the JCT-VC.

Summarizing, the present invention relates to filtering of image data at first with a deblocking and then with an adaptive loop filter, suitable for the purpose of video coding and decoding. In order to reduce requirements to a memory on chip, used to buffer image lines necessary for filtering, the input signal for the adaptive loop filter is determined from among deblocked pixels, non-deblocked pixels and partially (horizontally only or vertically only) deblocked pixels. The adaptive loop filtering of a deblocked pixel may then apply the filter taps to already deblocked pixels and/or undeblocked pixels and/or partially deblocked pixels in accordance with the determination of the input signal. An advantage of the invention is reduction of the line memory necessary especially at the decoder for processing with both filters.

We claim:

1. A method for filtering a current block of an image by applying a first filter and a second filter, wherein the first filter is applied first and the second filter processes an output of the first filter, the method comprising the steps of:
processing by the first filter predetermined pixels of current block by applying the first filter to the predetermined pixels and/or by determining whether to apply the first filter to the predetermined pixels;
processing at least one pixel of the current block, which has already been processed by said first filter, with the second filter, wherein at least one tap of the second filter is applied to at least one of said predetermined pixels before processing by said first filter.

2. A method according to claim 1, wherein said at least one predetermined pixel is a pixel processed only by vertical or only by horizontal component of the first filter and still to be processed with a horizontal of a vertical component of the first filter, respectively.

3. A method according to claim 1, wherein said at least one predetermined pixel is a pixel to which the first filter was not applied.

4. A method according to claim 1, wherein said at least one predetermined pixel is replaced for the filtering with the second filter with pixels from a different line in the current block, saved in a memory.

5. A method according to claim 1, further comprising a judging step for judging whether the second filter is to be applied to the predetermined pixels and for providing an indicator for indicating the result of the judging step.

6. A method according to claim 1, further comprising a judging step for deciding at least one of applying said at least one tap of the adaptive loop filter to deblocked, undeblocked, or partly deblocked pixels from either same pixel position or different pixel position within the current block.

7. A method according to claim 1, wherein the first filter is a deblocking filter and the second filter is an adaptive loop filter.

8. A method according to claim 7, wherein the predetermined pixels are pixels in three lines of pixels closest to the bottom boundary of the current block, the deblocking filter is applied to these predetermined pixels, the adaptive loop filter is applied to a pixel used by the deblocking filter or not to be used by the deblocking filter, and the taps of the adaptive loop filter are applied to the predetermined pixels before they are processed by the deblocking filter.

9. A method for encoding or decoding of a video signal including the steps of:
reconstructing a coded image signal with a decoding unit,
filtering the reconstructed image signal in accordance with the method of claim 1.

10. A computer program product comprising a computer-readable medium having a computer-readable program code embodied thereon, the program code being adapted to carry out the method according to claim 1.

11. An apparatus for filtering a current block of an image by applying a first filter and a second filter, wherein the first filter is applied first and the second filter processes an output of the first filter, the apparatus comprising:
a first filtering unit for processing predetermined pixels of current block by applying the first filter to the predetermined pixels and/or determining whether to apply the first filter to the predetermined pixels;
a second filtering unit for processing at least one pixel of the current block, which has already been processed by said first filter, with the second filter, wherein at least one tap of the second filter is applied to at least one of said predetermined pixels before processing by said first filter.

12. An apparatus according to claim 11, wherein said at least one predetermined pixel is a pixel processed only by vertical or only by horizontal component of the first filter and still to be processed with a horizontal of a vertical component of the first filter, respectively.

13. An apparatus according to claim 11, wherein said at least one predetermined pixel is a pixel to which the first filter was not applied.

14. An apparatus according to claim 11, wherein said at least one predetermined pixel is replaced for the filtering with the second filter with pixels from a different line in the current block, saved in a memory.

15. An apparatus according to claim 11, further comprising a judging unit for judging whether the second filter is to be applied to the predetermined pixels and for providing an indicator for indicating the result of the judging unit.

16. An apparatus according to claim 11, further comprising a judging unit for deciding at least one of applying said at least one tap of the adaptive loop filter to deblocked, undeblocked, or partly deblocked pixels from either same pixel position or different pixel position within the current block.

17. An apparatus according to claim 11, wherein the first filter is a deblocking filter and the second filter is an adaptive loop filter or vice versa.

18. An apparatus according to claim 17, wherein the predetermined pixels are pixels in three lines of pixels closest to the bottom boundary of the current block, the deblocking filter is applied to these predetermined pixels, the adaptive loop filter is applied to a pixel used by the deblocking filter or not to be used by the deblocking filter, and the taps of the adaptive loop filter are applied to the predetermined pixels before they are processed by the deblocking filter.

19. An apparatus for encoding or decoding of a video signal comprising:
a decoding unit for reconstructing a coded image signal,
a filtering unit according to claim 11 for filtering the reconstructed image signal.

20. An integrated circuit for embodying the apparatus of claim 11 further comprising a memory, which is a vertical and/or horizontal line memory for storing pixels to be filtered.
